(19) United States
(12) Patent Application Publication
(10) Pub. No.: US 2026/0280646 A1
(43) Pub. Date: Sep. 17, 2026

(54) CHANNEL STATE INFORMATION REPORTING METHOD AND APPARATUS

(71) Applicant: BEIJING XIAOMI MOBILE SOFTWARE CO., LTD., Beijing (CN)

(72) Inventors: Zhengxuan LIU, Beijing (CN); Min LIU, Beijing (CN)

(73) Assignee: BEIJING XIAOMI MOBILE SOFTWARE CO., LTD., Beijing (CN)

(21) Appl. No.: 19/471,381

(22) PCT Filed: Apr. 6, 2023
(86) PCT No.: PCT/CN2023/086721

§ 371 Date: Oct. 1, 2025

(51) Int. Cl. H04B 7/06; H04W 72/21

(52) U.S. Cl. CPC H04B 7/0626; H04B 7/0632; H04W 72/21

(57) ABSTRACT

A channel state information (CSI) reporting method is performed by a terminal. The terminal reports CSI to a network device, wherein the CSI comprises quantized information obtained by processing downlink channel information by a first model corresponding to each layer or a specific rank.

### CROSS-REFERENCE TO RELATED APPLICATION

This application is the US national phase application of International Application No. PCT/CN2023/086721, filed on Apr. 6, 2023, the entire contents of which are incorporated herein by reference for all purposes.

### TECHNICAL FIELD

The present disclosure relates to a field of communication technology, and specifically to a method and an apparatus for reporting channel status information.

### BACKGROUND

In related technologies, research and simulation results have shown that the use of artificial intelligence (AD)/machine learning (ML) and other technologies can reduce the feedback overhead of terminals or improve the accuracy of channel status information (CSI) feedback.

### SUMMARY

In a first aspect, embodiments of the present disclosure provide a method for reporting channel status information. The method is performed by a terminal and includes: reporting CSI by the terminal to a network device, wherein the CSI includes quantized information obtained after downlink channel information is processed by a first model corresponding to layer or a specific rank.

In a second aspect, embodiments disclosure provide another method for reporting channel status information. The method is performed by a network device, and includes: receiving reported by a terminal, wherein the CSI includes quantized information obtained after downlink channel information is processed by a first model corresponding to each layer or a specific rank.

In a third aspect, embodiments of the present disclosure provide a communication deice. The communication device has some or all of the functions of the terminal in the method described in the first aspect above, for example, the functions of the communication device may have some or all of the functions in the embodiments of the present disclosure, or may have the functions of separately implementing any of the embodiments of the present disclosure. The functions can be implemented through hardware or by executing corresponding software through hardware. The hardware or software includes one or more units or modules corresponding to the above functions.

In an implementation, the structure of the communication device may include a transceiver module and a processing module, wherein the processing module is configured to support the communication device to perform the corresponding functions in the above method. The transceiver module is configured to support communication between the communication device and other devices. The communication device may also include a storage module coupled with the transceiver module and the processing module, which stores necessary computer programs and data for the communication device.

In an implementation, the communication device includes: a transceiver module, configured to report CSI to a network device, wherein the CSI includes quantized information obtained after downlink channel information is processed by a first model corresponding to h layer or a specific rank.

In a fourth aspect, embodiments of the present disclosure provides another communication device. The communication device has some or all of the functions of the network device in the method described in the second aspect above, for example, the functions of the communication device may have some or all of the functions in the embodiments of the present disclosure, or may have the functions of separately implementing any of the embodiments of the present disclosure. The functions can be implemented through hardware or by executing corresponding software through hardware. The hardware or software includes one or more units of modules corresponding to the above functions.

In an implementation, the structure of the communication device may include a transceiver module and a processing module, wherein the processing module is configured to support the communication device to perform the corresponding functions in the above method. The transceiver module is configured to support communication between the communication device and other devices. The communication device may also include a storage module coupled with the transceiver module and the processing module, which stores necessary computer programs and data for the communication device.

In an implementation, the communication device includes: a transceiver module, configured to receive CSI reported by a terminal, wherein the CSI includes quantized information obtained after downlink channel information is processed by a first model corresponding to each layer or a specific rank.

In a fifth aspect, embodiments of the present disclosure provide a communication device. The communication device includes a processor. When the processor calls a computer program stored in a memory, the method described in the first aspect is implemented.

In a sixth aspect, embodiments of the present disclosure provide a communication device. The communication device includes a processor. When the processor calls a computer program stored in a memory, the method described in the second aspect is implemented.

In a seventh aspect, embodiments of the present disclosure provide a communication device. The communication device includes a processor and a memory. The memory stores a computer program, processor is configured to execute the computer program stored in the memory, to cause the communication device to implement the method described in the first aspect.

In an eighth aspect, embodiments of the present disclosure provide a communication device. The communication device include a processor and a memory. The memory stores a computer program. The processor is configured to execute the computer program stored in the memory, to cause the communication device to implement the method described in the second aspect.

In a ninth aspect, embodiments of the present disclosure provide a communication device. The communication device includes a processor and an interface circuit. The interface circuit is configured to receive code instructions and transmit the code instructions to the processor. The processor is configured to run to implement the code instruction e method d in the first aspect.

In a tenth aspect, embodiments of the present disclosure provide a communication device. The communication device includes a processor and an interface circuit. The interface circuit is configured to receive code instructions and transmit the code instructions to the configured to run the code instructions, to cause the device to implement the method described in the second aspect.

In an eleventh aspect, embodiments of the present disclosure p system for reporting channel status information. The system includes the communication device as described in the third aspect and, the communication device as described in the fourth aspect, or the system includes the communication device as, described in the fifth aspect and the communication device as described in the sixth aspect of the system includes the communication device as described in the seventh aspect and the communication device as described in the eighth aspect, or the system includes the communication device as described in the ninth aspect and the communication device as described in the tenth aspect.

In a twelfth aspect, embodiments of the present disclosure provide a computer readable storage medium for storing instructions for use by the terminal, and when the instructions are executed, the terminal is caused to implement the method described in the first aspect.

In a thirteenth aspect, embodiments of the present disclosure provide a computer readable storage medium for storing instructions for use by the network device, and when the instructions are executed, the network device is caused to implement the method described in the second aspect.

In a fourteenth aspect, the present disclosure also provides a computer program product including a computer program that, when executed on a computer, causes the computer to perform the method described in the first aspect.

In a fifteenth aspect, the present disclosure also provides a computer program product including a computer program that, when executed on a computer, causes the computer to perform the method described in the second asp ct.

In a sixteenth aspect, the present disclosure provides a chip system including at least one processor and an interface for supporting the terminal to implement the functions involved in the methods described in the first aspect, such as determining or processing at least one of the data and information involved in the above methods. In a possible design, the chip system further includes a memory for storing computer programs and data necessary for the terminal. This chip system can be composed of chips or include chips and other discrete component.

In a seventeenth aspect, the present disclosure provides a chip system including at least one processor and an interface for supporting the network device to implement the functions involved in the methods described in the second aspect, such as determining or processing at least one of the data and information involved in the above methods. In a possible design, the chip system further includes a memory for storing computer programs and ta necessary for the network device. This chip system can be composed of chips or include chips and other discrete components.

In an eighteenth aspect, the present disclosure provides a computer program that, when executed on a computer, causes the computer to perform the method described in the first aspect.

In a nineteenth aspect, the present disclosure provides a computer program that, when executed on a computer, causes the computer to perform the method described in the second aspect.

### BRIEF DESCRIPTION OF THE DRAWINGS

In order to provide a clearer explanation of the technical solution in embodiments of the present disclosure or background technology, the companying drawings required for use in embodiments of the present disclosure or background technology will be described below.

FIG. 1 is a schematic diagram of architecture of a communication system provided in an embodiment of the present disclosure.

FIG. 2 is a schematic diagram of CSI compression feedback and recovery based on a bilateral AI/ML model provided in an embodiment of the present disclosure.

FIG. 3 is a flowchart of a method for reporting channel status information provided in an embodiment of the present disclosure.

FIG. 4 is a flowchart of another method for reporting channel status information provided in an embodiment of the present disclosure.

FIG. 5 is a flowchart of a method for determining a load provided in an embodiment of the present disclosure.

FIG. 6 is a flowchart of a method for sending model indication information provided in an embodiment of the present disclosure.

FIG. 7 is a flowchart of a method for reporting auxiliary information provided in an embodiment of the present disclosure.

FIG. 8 is a flowchart of yet another method for reporting channel status information provided in an embodiment of the present disclosure.

FIG. 9 is a flowchart of yet another method for reporting channel status information provided in an embodiment of the ent disclosure.

FIG. 10 is a flowchart of another method for sending model indication information provided in an embodiment of the present disclosure.

FIG. 11 is a flowchart of another method for reporting auxiliary information provided in an embodiment of the present disclosure.

FIG. 12 is a block diagram of a communication device provided in an embodiment of the present disclosure.

FIG. 13 is a block diagram of another communication device provided in an embodiment of the present disclosure.

FIG. 14 is a block diagram of a chip provided in an embodiment of the present disclosure.

### DETAILED DESCRIPTION

In order to better understand the method and device for reporting channel status information disclosed in embodiments of the present disclosure, the following first describes the communication system applicable to embodiments of the ent disclosure.

The following provides a detailed description of the embodiments of the present disclosure, examples of which are shown in the accompanying drawings, where the same or similar reference numerals throughout represent same or similar elements or elements with the same or similar functions. The embodiments with reference to the accompanying drawings are exemplary and intended to explain the prese disclosure, and should not be construed as limiting the present disclosure. In the description disclosed herein, unless otherwise specified “/” means “or”, for example, A/B can represent A or B; “and/or” in this article is only a description of the association relationship between related objects, indicating that there can be three types of relationships, for example, A and/or B can represent; the existence of A alone, the existence of A and B at the same time, and the existence of B alone.

In order to facilitate understanding of the technical solution of the present disclosure, the following briefly introduces some terms involved in the embodiments of the present disclosure.

### 1. SD (Spatial Domain) Basis Vector

In embodiments of the present disclosure, the spatial domain may include a sending side spatial domain and a receiving side spatial domain, and the SD basis vector may be determined based on the sending side SD basis vector. Each sending side SD basis vector can correspond to a sending beam of the sending end device. Each receiving side SD basis vector can correspond to a receiving beam of the receiving end device.

Taking the sending side SD basis vector as an example, the receiving side SD basis vector is similar to the sending side SD basis vector. The sending side SD basis vector is usually associated with the sending side antenna array. For example, many parameters involved in the ex tion of the sending side SD basis vector can be understood as representing different properties of the sending side antenna array. However, those skilled in the art should understand that the sending id vectors involved in embodiments of the present disclosure are not limited to a specific antenna array. In the specific implementation process, a suitable antenna array can be selected according to specific needs, and based on the selected antenna array, various parameters involved in the sending side SD basis vector involved in embodiments of the present disclosure can be set.

### 2. FD (Frequency Domain) Basis Vector

The FD basis vector is used to characterize a variation pattern of a channel in the frequency domain. The FD basis vector can be specifically used to represent the variation pattern of the weighting coefficients of each SD basis vector on each frequency domain unit. The variation pattern represented by the FD basis vector is related to factors such as multipath delay. It can be understood that signals may have different transmission delays on different transmission paths when transmitted through wireless channels. The frequency domain variation of channels caused by different transmission delays can be characterized by different FD basis vectors.

In embodiments of the present disclosure, the dimension of the FD basis vector is Nf, which means that one FD basis vector contains Nf elements.

Optionally, the dimension of the FD basis vector can be equal to the number of frequency domain units that require channel status information (CSI) measurement. Due to the varying number of frequency domain units requiring CSI measurement at different moments, the dimensions of the FD basis vectors may also differ. In other words, the dimension of the FD basis vector is variable.

Optionally, the dimension of the FD basis vector can also be equal to the number of frequency domain units included in the available bandwidth of the terminal. The available bandwidth of the terminal can be configured by the network device. The available bandwidth of the terminal is a part or all of the system bandwidth. The available bandwidth e terminal can also be referred to as bandwidth part (BWP), which is not limited in embodiments of the present disclosure.

Optionally, the length of the FD basis vector can also be equal to the length of the signaling, used to indicate the position and number of frequency domain units to be reported, for example, the length of the FD basis vector can be equal to the number of bits in the signaling, and so on. For example, in new radio (NR), the signaling used to indicate the position and number of frequency domain units to be reported may be the signaling used to report the bandwidth. This signaling can indicate the position and number of frequency domain units to be reported, for example, in the form of a bitmap. Therefore, the dimension of the FD basis vector can be the number of bits of the bitmap.

### 3. TD (Time Domain) Basis Vector or DD (Doppler Domain) Basis Vector

The TD basis vector or DD basis vector is used to characterize a variation pattern of a channel in the time domain. That is, the TD basis vector or DD basis vector is used to characterize the time-varying nature of the channel. The time-varying nature of the channel refers to the variation of its transfer function over time. The time-varying nature of the channel is related to factors such as Doppler shift.

In embodiments of the present disclosure, the dimension of the TD or DD basis vector is meaning that one TD or DD basis vector contains Nt elements.

Optionally, the dimension of the TD or DD basis vector can be equal to the number of time units that require CSI measurement. It can be understood that due to the varying number of time units requiring CSI measurement in the dimensions of TD or DD basis vectors may also differ. In other words, the dimension of the TD or DD basis vector is variable.

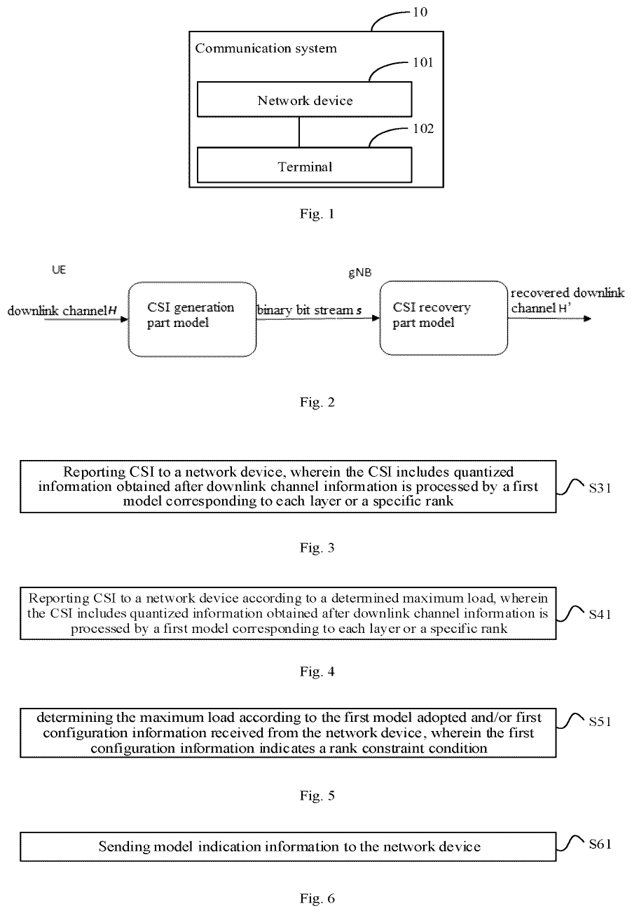

Please refer to FIG. 1, which is a schematic diagram of architecture of a communication system provided in an embodiment of the present disclosure. The communication system may include but is not limited to one network device and one terminal. The number and form of devices shown in FIG. 1 are for example only an a limitation on the embodiments of the present disclosure. In applications, it may include two or more than two network de more than two terminals. The communication system shown in FIG. 1 takes the example of including one network device 101, and one terminal 102.

It should be noted that the technical solution disclosed in embodiments of the present disclosure can be applied to various communication systems, for example, Long Term Evolution (LTE) systems, 5th generation (5G) mobile communication systems, 5G new radio (NR) systems, or other future new mobile communication systems.

The network device 101 in embodiments of the present disclosure is an entity on the network side used for transmitting or receiving signals. For example, the network device may be an evolved NodeB (eNB), a transmission reception point (TRP), a radio remote head (RRH), a next generation NodeB (gNB) in an NR system, a base station in other future mobile communication systems, or an access node in a wireless fidelity (Wi-Fi) system. The specific technology and device form adopted by the base station is not limited in embodiments of the present disclosure. The base station provided in embodiments of the present disclosure may be composed of a central unit (CU) and distributed units (DUs), where the CU may also be referred to as a control unit. The CU-DU structure can be used to separate the base station, such as the protocol layers of the base station, with some protocol layer functions centrally controlled by the CU and the remaining or all protocol layer functions distributed in the DUs, which are centrally controlled by the CU.

The terminal 102 in embodiments of the present disclosure is an entity on the user side used for receiving or transmitting signals, such as a mobile phone. The terminal may also be referred to as terminal device, user equipment (UE), mobile station (MS), mobile terminal (MT), etc. The terminal may be communication enabled car, smart car, mobile phone, wearable device, tablet, computer with wireless transmission and reception capabilities, virtual reality (VR) terminal, augmented reality (AR) terminal, wireless terminal in industrial control, wireless terminal in self-driving, wireless terminal in remote medical surgery, wireless terminal in smart grid, wireless terminal in transportation safety, wireless terminal in smart city and, wireless terminal in smart home, etc. The specific technology and device form adopted by the terminal is not limited in embodiments of the present disclosure.

It can be understood that the communication system described in embodiments of the present disclosure is for a clearer explanation of the technical solution provided in embodiments of the present disclosure, and does not constitute a limitation on the technical solution provided in embodiments of the present disclosure. Thos rt know at w the evolution of system architecture and the emergence of new business scenarios, the technical solution provided in embodiments of the present disclosure is also applicable to similar technical problems.

Furthermore, for the convenience of understanding embodiments of the present disclosure, the following explanations are made.

Firstly, in embodiments of the present disclosure, “indicating” may include both directly indicating and indirectly indicating. When scribing a certain information indicating A, it can include the information carrying A, or it can also include the information directly indicating A or indirectly indicating A, but it does not necessarily mean that A is carried in the information.

The information indicated by the information is referred to as the information to be indicated, and there are many ways to indicate the information to be indicated in the specific implementation process, such as but not limited to directly indicating the information to be indicated, such as the information itself or the index of the information to be indicated. It is also possible to indirectly indicate the information to be indicated by indicating other information, where there is a correlation between the other information and the information to be indicated. It is also possible to indicate only a part of the information to be indicated, while the other parts of the information to be indicated are known or pre agreed upon. For example, it is also possible to use the pre-agreed (such as protocol provisions) arrangement order of various information to achieve the indication of specific information, thereby reducing the indication overhead to a certain extent.

The information to be indicated can be sent together as a whole or divided into multiple sub information for separate transmission, and the transmission period and/or timing of these sub information can be the same or different. The specific transmission method is not limited in this disclosure. The transmission period and/or timing of these sub information can be predefined, such as according to the protocol.

Secondly, in this disclosure, the first, second, and various numerical designations (e.g., “#/2”) are only for the convenience of description and are not intended to limit the scope of the embodiments of the present disclosure. For example, they are used to distinguish different types of information.

Thirdly, embodiments of the present disclosure list multiple implementations to clearly illustrate the technical solution of the embodiments of the present disclosure. Of course, those skilled in the art can understand that the multiple embodiments provided in this disclosure can be executed separately, combined with the methods of other embodiments in this disclosure, or executed separately or in combination with some methods in other related technologies, which is not limited in this disclosure.

In related technologies, while a terminal sends information to a network device on a certain frequency band, the network device needs to send information to the terminal on another frequency band. The terminal needs to transmit and receive simultaneously on multiple frequency bands, which can cause interference between the multiple frequency bands that are transmitting and receiving simultaneously. This is an urgent problem that needs to be solved.

In related technologies, research and simulation results have shown that the use of AI/ML and other technologies can reduce the feedback overhead of terminals or improve the accuracy of channel status information (CSI) feedback.

In the research of the 3rd Generation Partnership Project (3GPP), a paired (bilateral) AI/ML model of the CSI generation part model on the terminal side and the CSI recovery part model on the network device side were developed to achieve CSI compression feedback and recovery respectively.

As shown in FIG. 2, a schematic diagram of CSI compression feedback and recovery based on a bilateral AI/ML model is presented. The terminal (UE) compresses the downlink channel information H through the CSI generation part model, and then performs quantization to obtain a binary bit stream, and sends the binary bit stream to the network device (g B). The network device uses the CSI recovery part model to recover H′ that is similar to the original downlink channel information.

It should be noted that there are many types of CSI generation part models, which are related to the data used during training, the training method, and the basic model used. The terminal can also directly compress and quantize the downlink channel information H into a binary bit stream through the CSI generation part model.

The methods for training the bilateral model of CSI generation part model and CSI recovery part model include the following:
Rank specific method: Train one bilateral model that includes the CSI generation part model and the CSI recovery part model for each rank;
Rank common method: Train only one bilateral model that includes the CSI generation part model and the CSI recovery part model for all ranks;
Layer specific method: Train one bilateral model that includes the CSI generation part model and the CSI recovery part model for each layer;
Layer common method: Train only one bilateral model that includes the CSI generation part model and the CSI recovery part model for all layers.

In related technologies, the CSI feedback method adopts Rel-16 Type II codebook or Rel-17 Type II codebook for CSI feedback.

In the CSI feedback of Rel-16 Type II codebook or Rel-17 Type II codebook, the CSI is divided into the first part (Part 1) and the second part (Part 2) for reporting, as shown in Table 1.

TABLE 1

| codebook | Part 1 | Part 2 |
|---|---|---|
| Rel-16 | rank | G0: SD basis vector indication information and strongest coefficient |
| Type II | indication (RI) | indication information in each polarization direction |
| codebook | channel quality | G1: FD basis vector indication information, high priority non-zero |
| | indicator (CQI) | coefficient indication information, amplitude and phase quantization |
| | and quantities | information corresponding to non-zero coefficients of high priority other |
| | of non-zero | than the strongest coefficient |
| | coefficients | G2: low priority non-zero coefficient indication information, amplitude |
| | of all | and phase quantization information corresponding to low priority |
| | layers | non-zero coefficients |
| Rel-17 | | G0: port selection indication information, strongest coefficient indication |
| Type II port | | information, and FD basis vector indication information in each |
| selection | | polarization direction |
| codebook | | G1: high priority non-zero coefficient indication information, amplitude |
| | | and phase quantization information corresponding to non-zero |
| | | coefficients of high priority other than the strongest coefficient |
| | | G2: low priority non-zero coefficient indication information, amplitude |
| | | and phase quantization information corresponding to low priority |
| | | non-zero coefficients |

However, for the bilateral AI/ML model, there are multiple ways to train the bilateral model of CSI generation part model and CSI recovery part model. How to report the CSI by the terminal is an urgent problem that needs to be solved.

Based on this, embodiments of the present disclosure propose a method for reporting channel status information. The terminal reports CSI to the network device, wherein the CSI includes quantized information obtained after downlink channel information is processed by a first model corresponding to each layer or a specific rank. Thus, the terminal can report the CSI including the quantized information obtained after the downlink channel information is processed by the first model corresponding to each layer or the specific rank, so that the network device can obtain accurate CSI.

The following provides a detailed introduction to a method and device for reporting channel status information provided in this disclosure, in conjunction with the accompanying drawings.

Please refer to FIG. 3, which is a flowchart of a method for reporting channel status information provided in an embodiment of the present disclosure. As shown in FIG. 3, the method is performed by a terminal, and the method may include but is not limited to the following step:

S31, reporting CSI to a network device, wherein the CSI includes quantized information obtained after downlink channel information is processed by a first model corresponding to each layer or a specific rank.

In an embodiment of the present disclosure, the terminal can report the CSI to the network device, wherein the CSI includes quantized information obtained after downlink channel information is processed by a first model corresponding to each layer or a specific rank.

In an embodiment of the present disclosure, the terminal can use the first model to process the downlink channel information to obtain the quantized information. The first model may be the CSI generation part model on the terminal side.

The first model can infer and/or predict the downlink channel information to obtain the quantized information.

It can be understood that there are many types of the first model, which are related to the data, used in training, training methods and basic models used.

In a possible implementation, the terminal can obtain the quantized information after processing the downlink channel information using the first model and performing vector quantization.

In another possible implementation, the terminal can directly obtain the quantized information after processing the downlink channel information using the first model, in which the first model performs vector quantization.)

In an embodiment of the present disclosure, the CSI includes the quantized information obtained after the downlink channel information is processed by the first model corresponding to each layer or a specific rank.

The CSI reported by the terminal to the network device includes the quantized information obtained after the downlink channel information is processed by the first model corresponding to each layer.

It can be understood that in the case of multiple layers, the first models corresponding to different layers may be the same or different. Based on this, the terminal can report the quantized information obtained by processing the downlink channel information with the first model corresponding to each layer to the network device:

The CSI reported by the terminal to the network device includes the quantized information obtained after the downlink channel information is processed by the first model corresponding to the specific rank.

It can be understood that the network device can indicate the maximum transmission rank of the uplink transmission of the terminal. In the case of rank ≥1, the first models corresponding to different ranks may be the same or different. The terminal can select one of the ranks as the specific rank and report the quantized information obtained after the downlink channel information is processed by the first model corresponding to the specific rank to the network device.

In some embodiments, the terminal sends model indication information to the work, wherein the model indication information indicates at least one of:
indication information of the first model;
indication information of a second model matched with the first model; or
indication information of a model pair of the first model and the second model matched;
wherein the second model is configured to process the quantized information to recover predicted downlink channel information similar to the downlink channel information.

In an embodiment of the present disclosure, the terminal may send the model indication information to the network device, wherein the model indication information may include the indication information of the first model.

The indication information of the first model can indicate the first model, and can inform the network device of the information of the first model used by the terminal.

In an embodiment of the present disclosure, the terminal may send the model indication information to the network device, wherein the model indication information may include indication information of the second model matched with the first model, wherein the second model is configured to process the quantized information to recover predicted downlink channel information similar to the downlink channel information.

The second model matched with the first model may be the CSI recovery part model on the network device side. The first model and the second model may be obtained by training in the rank specific method, the rank common method, the layer specific method of the layer common method described above for example.

The indication information of the second model matched with the first model can indicate the second model, informing the network device of information of the second model that it should use, which can inform the network device to use the corresponding second model for processing, wherein the second model is matched with the first model.

In an embodiment of the present disclosure, the terminal may send the model indication information to the network device, wherein the model indication information may include indication information of a model pair of the first model and the second model matched, wherein the second model is configured to process the quantized information to recover predicted downlink channel information similar to the downlink channel information.

The indication information of the model pair of the first model and the matched second model can indicate the information of the model pair of the first model and the second model, informing the network device of the information of the first model used by the terminal and the information of the second model matched with the first model, which can inform the network device to use the corresponding second model for processing.

It should be noted that the above dim t exhaustive and are only illustrative of some embodiments. The above embodiments can be implemented separately or in a combined manner. The above embodiments are only illustrative and do not serve as specific limitations on the scope of protection of the present disclosure.

In some embodiments, one or more candidate first models can be configured at the terminal, and the terminal can select one as the first model.

In other embodiments, the terminal can receive configuration information from the network device. The configuration information is used to indicate ne ore candidate first models. In the case where the configuration information indicates first model, the terminal can determine that the candidate first model is the first model. In the case where the configuration information indicates multiple candidate first models, the terminal can select one of them as the first model.

It should be noted that if the configuration information from the network device only indicates one candidate first model, because there is only one candidate first model, the terminal will inevitably select the candidate first model as the first model, and the network device can know the first model selected by the terminal. Based on this, the terminal may not report the indication information of the first model.

In some embodiments, the CSI further includes at least one of:
RI;
CQI;
indication information of the first model;
indication information of the second model matched with the first model; or
indication of a model pair of the first model and the second model matched,
wherein the second model is configured to process the quantized information to recover predicted downlink channel information similar to the downlink channel information.

In an embodiment of the present disclosure, the CSI may further include RI. The terminal can determine the RI based on the constraints configured by network device and report t the RI to the network device.

In an embodiment of the present disclosure, the CSI may further include CQI.

In an embodiment of the present disclosure, the CSI may further include the indication information of the first model.

The indication information of the first model can indicate the first model, and can inform the network device of the information of the first model used by the terminal.

In an embodiment of the present disclosure, the CSI may further include indication information of the second model matched with the first model, wherein the second model is configured to process the quantized information to recover predicted downlink channel information similar to the downlink channel information.

The second model matched with the first model may be the CSI recovery part model on the network device side. The first model and the second model may be obtained by training in the rank specific method, the rank common method, the layer specific method of the layer common method described above for example.

The CST further includes the indication information of the second model matched with the first model, which can indicate the second model, informing the network device of information of the second model that it should use, which can inform the network device to use the corresponding second model for processing, wherein the second model is matched with the first model.

In an embodiment of the present disclosure, the CSI may further include indication information of a model pair of the first model and the second model matched, wherein the second model is configured to process the quantized information to recover predicted downlink channel information similar to the downlink channel information.

The terminal may report the indication information of the model pair, informing the network device of the information of the first model used by the terminal and the information of the second model matched with the first model, which can inform the network device to use the corresponding second model for processing.

It should be noted that the above embodiments are not exhaustive and are only illustrative of some embodiments. The above embodiments can be implemented separately or in a combined manner. The above embodiments are only illustrative and do not serve as specific limitations on the scope of protection of the present disclosure.

In some embodiments, when the terminal reports the CSI to the network device, the content of CSI may be reported as a whole, or may be split for reporting separately in multiple times.

In some embodiments, if the terminal chooses to split the content of CSI for reporting separately in multiple times, the terminal can report separately in multiple times at different moments, to achieve reporting the CSI to the network device.

In some embodiments, reporting the CSI by the terminal to the network device includes: reporting a first part of information and a second part of information to the network device at different moments, wherein the CSI includes the first part of information and the second part of information.

In an embodiment, when the terminal reports the CSI to the network device the terminal may report the first part of information and the second part of information to the network device at different moments.

The CSI includes the first part information and the second part of information.

In some embodiments, reporting the first and second parts of information by the terminal to the network device includes: reporting the first part of information to the network device using a Physical Uplink Shared Channel (PUSCH) or a Physical Uplink Control Channel (PUCCH), and reporting the second part of information to the network device using the PUSCH or the PUCCH.

In an embodiment of the present disclosure, the terminal may report the first part of information to the network device using the PUSCH or PUCCH, and report the second part of information to the network device using the PUSCH or PUCCH.

In some embodiments, reporting the first part of information and the second part of information by the terminal to the network device includes:
reporting the first part of information and the second part of information to the network device periodically; of
reporting the first part of information and the second part of information to the network device non-periodically; or
reporting the first part of information and the second part of information to the network device semi-continuously.

The first part of information is associated with the second part of information following and adjacent to the first part of information.

In an embodiment of the present disclosure, the terminal may report the first part of information and the second part of information to the network device periodically, wherein the first part of information is associated with the second part of information following and adjacent to the first part of information.

In an embodiment of the present disclosure, the terminal may report the first part of information and the second part of information to the network device non-periodically, wherein the first part of information is associated with the second part of information following and adjacent to the first part of information.

In an embodiment of the present disclosure, the terminal may report the first part of information and the second part of information to the network device semi-continuously, wherein the first part of information is associated with the second part of information following and adjacent to the first part of information.

It can be understood that the content of the first part of information reported by the terminal corresponds to the second part of information reported immediately after it, and the first part of information is associated with the second part of information reported immediately after it.

In an embodiment of the present disclosure, which first part of information is associated with the reported second part of the information can be determined through pre-defined or reported identifiers. The first part of the information corresponds to the first identifier, and the second part of the information corresponds to the second identifier. It can be reported that the first identifier is associated with the second identifier to determine the first part of the information corresponding to the second part of information.

In some embodiments, the first part of information includes at least one of:
RI;
CQI;
indication information of the first model; or
indication information of a second model matched with the first model;
the second part of information includes at least one of:
the quantized information obtained after the downlink channel information is processed by
the first model corresponding to each model;
lengths of the quantized information of all layers obtained after the downlink channel information is processed by the first models corresponding to the all layers;
quantities of code words of all layers obtained after the downlink channel information is processed by the first models corresponding to the all layer;
the quantized information obtained after the downlink channel information is processed by the first model corresponding to the specific rank; or indication information of the first model.

In an embodiment of the present disclosure, the first part of information may include at least one of
RI;
CQI;
indication information of the first model; or
indication information of a second model matched with the first model.

The second part of information may include at least one of
the quantized information obtained after the downlink channel information is processed by the first model corresponding to each model;
lengths of the quantized information of all layers obtained after the downlink channel information is processed by the first models corresponding to the all layers;
quantities of code words of all layers obtained after the downlink channel information is processed by the first models corresponding to the all layer;
the quantized information obtained after the downlink channel information is processed by the first model corresponding to the specific rank; or
indication information of the first model.

It should be noted that in the case that the first part of information does not include the indication information of the first model, the second part of information may include the indication information of the first model.

It should be noted that in the case that the network device only configures one first model for the terminal, the first part of information and the second part of information may not include the indication information of the first model.

In some embodiments, the first model and the second model are obtained by training according to a corresponding layer; or the first model and the second model are obtained by training according to a corresponding rank.

In an embodiment of the present disclosure, the first model and the second model are obtained by training according to a corresponding layer, wherein the first model and the second model may be obtained by training in a layer specific manner, or may be obtained by training in a layer common manner.

In an embodiment of the present disclosure, the first model and the second model are obtained by training according to a corresponding rank, wherein the first model and the second model may be obtained by training in a rank specific manner, or may be obtained by training in a layer common manner.

In an embodiment of the present disclosure, the first model and the second model may be obtained by training in a layer specific manner, or may be obtained by training in a layer common manner.

When the first model and the second model are obtained by training in a layer specific manner, a bilateral model containing the first model and the second model can be obtained for each layer.

When the first model and the second model are obtained by training in a layer common manner, only one bilateral model containing the first model and the second model can be obtained for all layers.

In an embodiment of the present disclosure, if the first model and the second model are obtained by training according to the corresponding layer, the first part of information includes at least one of:
RI;
CQI;
indication information of the first model;
indication information of the second model matched with the first model;
a length of the quantized information obtained after the downlink channel information is processed by the first model corresponding to each layer; or
a quantity of code words obtained after the downlink channel information is processed by the first model corresponding to each layer.

The second part of information includes the quantized information obtained after the downlink channel information is processed by the first model corresponding to each layer.

In an embodiment of the present disclosure, the first model and the second model may be obtained by training in a rank specific manner, or may be obtained by training in a rank common manner.

When the first model and the second model are obtained by training in a rank specific manner, a bilateral model containing the first model and the second model can be obtained for each rank.

When the first model and the second model are obtained by training in a rank common manner, only one bilateral model containing the first model and the second model can be obtained for all ranks.

In an embodiment of the present disclosure, if the first model and the second model are obtained by training according to the corresponding rank, the first part of information includes at least one of:
RI;
CQI
indication information of the first model;
indication information of the second model matched with the first model;
a length of the quantized information obtained after the downlink channel information is processed by the first model corresponding to the specific rank; or
a quantity of code words obtained after the downlink channel information is processed by the first model corresponding to the specific rank.

The second part of information includes the quantized information obtained after the downlink channel information is processed by the first model corresponding to the specific rank.

In some embodiments, data input to the first model may include two types, one is a precoding matrix in a space-frequency domain, and the other is a precoding matrix in an angle-time delay domain.

No matter what type of data is input to the first model, the information included in the first part model and the second part model may be the same as the content included in the first part of information and the second part of information described in some embodiments above.

It can be understood that in an embodiment of the present disclosure, the first part of the information includes the indication information of the first model, and the length of the quantized information obtained after the downlink channel information is processed by the first model corresponding to each layer of each rank can also be directly determined. The terminal may not need to report the length of the quantized information obtained after the downlink channel information is processed by the first model corresponding to each layer or each rank, thus reducing the feedback overhead of the terminal.

In some embodiments, data input to the first model includes a precoding matrix in a space-frequency domain, or a precoding matrix in an angle-time delay domain, wherein in a case where the data input to the first model is the precoding matrix in the angle-time delay domain, the second part of information further includes indication information of spatial and frequency domain basis vectors selected by the terminal.

In an embodiment of the present disclosure, data input to the first model may include two types, one is a precoding matrix in a space-frequency domain, and the other is a precoding matrix in an angle-time delay domain.

In the case where the data input to the first model is the precoding matrix in the space-frequency domain, the information included in the first part model and the second part model may be the same as the content included in the first part of information and the second part of information described in some embodiments above.

In the case where the data input to the first model is the precoding matrix in the angle-time delay domain, the information included in the first part model may be the same as the content included in the first part of information described in some embodiments above, and the second part of information may also include indication information of the spatial and frequency domain basis vectors selected by the terminal in addition to the content described in some embodiments above:

It can be understood that the terminal can determine the indication information of the spatial and frequency domain basis vectors based on the configuration of the network device. In this case, the terminal does not need to report the indication information of the spatial and frequency domain basis vectors. If the terminal selects the indication information of the spatial and frequency domain basis vectors, the terminal needs to report the indication information of the spatial and frequency domain basis vectors.

In some embodiments, the CSI further includes code word indication information of vector quantization, wherein the quantized information is obtained after the downlink channel information is processed by the first model and then is processed with the vector quantization.

In an embodiment of the present disclosure, in the case that the quantized information is, obtained after the downlink channel information is processed by the first model and then is processed with the vector quantization, the CSI may further include code word indication information of the vector quantization.

In some embodiments, the terminal reports auxiliary information to the network device, wherein the quantized information is obtained after the downlink channel information is processed by the first model and then is processed with vector quantization, and the auxiliary information includes code word indication information of the vector quantization.

In an embodiment of the present disclosure, in the case that the quantized information is obtained after the downlink channel information is processed by the first model and then is processed with vector quantization, the terminal may report auxiliary information to the network device, and the auxiliary information includes code word indication information of the vector quantization.

In this implementation or embodiment, respective steps can be independently executed, arbitrarily combined, or exchanged in order without contradiction, and optional implementations or embodiments can be arbitrarily combined and can be combined with other embodiments or implementations in any way.

By implementing the embodiments of the present disclosure, the terminal reports the CSI to the network device, wherein the CSI includes the quantized information obtained after the downlink channel information is processed by the first model corresponding to each layer or specific rank. Thus, the terminal can report the CSI including the quantized information obtained after the downlink channel information is processed by the first model corresponding to each layer or specific rank, so that the network device can obtain accurate CSE

Please refer to FIG. 4, which is a flowchart of another method for reporting channel status information provided in an embodiment of the present disclosure. As shown in FIG. 4, the method is performed by a terminal, and the method may include but is not limited to the following step:

S41, reporting SCI to a network device according to a determined maximum load, wherein the CSI includes quantized information obtained after downlink channel information is processed by a first model corresponding to each layer or a specific rank.

In an embodiment of the present disclosure, the terminal may report the CSI to the network device according to the determined maximum load.

The relevant description of the terminal reporting CSI to the network device can be found in the above embodiments, which will not be repeated here.

The terminal can determine the maximum load based on the configuration of the network device, or the terminal can also determine the maximum load based on other information, which is not specifically limited in embodiments of the present disclosure.

In some embodiments, the terminal determines the maximum load according to the first model adopted and/or first configuration information received from the network device, wherein the first configuration information indicates a rank constraint condition.

In an embodiment of the present disclosure, the terminal may determine the maximum load according to the adopted first model.

In an embodiment of the present disclosure, the terminal may determine the maximum load according to the first configuration information received from the network device.

The first configuration information is used to indicate a rank condition. The terminal may determine the maximum load according to the rank constraint condition sent by the network device.

It can be understood that the terminal determines the maximum load according to the first model adopted and/or the first configuration information received from the network device, so that the network device does not need to configure the maximum load for the terminal, which can reduce signaling overhead.

In an embodiment of the present disclosure, the terminal reports CSI to the network device based on the determined maximum load. If the CSI is less than the maximum load, the remaining part is filled with zeros and reported to the network device.

In the case where CSI is equal to the maximum load, CSI can be directly reported to the network device.

In the case where CSI is greater than the maximum load, the whole CSI can be discarded, or some information in CSI can be discarded and the remaining information of CSI can be reported to the network device, wherein some information in CSI can be discarded according to a CSI discarding criteria or method.

In this embodiment or implementation, respective steps can be independently executed, arbitrarily combined, or exchanged in order without contradiction, and optional embodiments, of implementations can be arbitrarily combined and can be combined with other embodiments or implementations in any way.

It should be noted that in this embodiment of the present disclosure, S41 can be implemented separately or in combination with any other step in embodiments of the present disclosure, such as in combination with S31 in embodiments of the present disclosure, which is not limited in embodiments of the present disclosure.

By implementing the embodiments of the present disclosure, the terminal reports the CSI to the network device according to the determined maximum load, wherein the CSI includes the quantized information obtained after the downlink channel information is processed by the first model corresponding to each layer or a specific rank. Thus, according to the determined maximum load, the terminal can report the CSI including the quantized information obtained after processing the downlink channel information by the first model corresponding to each layer or a specific rank, so that the network device can obtain accurate CSI.

Please refer to FIG. 5, which is a flowchart of a method for determining a load provided in an embodiment of the present disclosure. As shown in FIG. 5, the method is performed by a terminal, and the method may include but is not limited to the following step:

S51, determining the maximum load according to the first model adopted and/or the first configuration information received from the network device, wherein the first configuration information indicates a rank constraint condition.

In an embodiment of the present disclosure, the terminal may determine the maximum load according to the adopted first model.

In an embodiment of the present disclosure, the terminal may determine the maximum load according to the first configuration information received from the network device.

The first configuration information is used to indicate the rank constraint condition. The terminal may determine the maximum load according to the rank constraint condition sent by the network device.

It can be understood that the terminal determines the maximum load according to the first model adopted and/or the first configuration information received from the network device, so that the network device does not need to configure the maximum load for the terminal, which can reduce signaling overhead.

In an embodiment of the present disclosure, the terminal may determine the first model adopted based on an implementation of the terminal, or may also determine the first model adopted based on the protocol agreement, or may also determine the first model adopted based on the configuration of the network side device.

The configuration of the network device may indicate one or more candidate first models, and the terminal may determine that one of them is the adopted first model.

In some embodiments, the terminal receives second configuration information sent by the network device, wherein the second configuration information indicates a plurality of candidate first models, and determines one of the plurality of candidate first models as the first model adopted.

In an embodiment of the present disclosure, the terminal may receive the second configuration information sent by the network device, wherein the second configuration information indicates a plurality of candidate first models. Thus, the terminal may determine one of the plurality of candidate first models as the first model adopted.

In this embodiment or implementation, respective steps can be independently executed, arbitrarily combined, or exchanged in order without contradiction, and optional embodiments of implementations can be arbitrarily combined and can be combined with other embodiments or implementations in any way.

It should be noted that in this embodiment of the present disclosure, S51 can be implemented separately or in combination with any other step in embodiments of the present disclosure, such as in combination with S31 and/or S41 in embodiments of the present disclosure, which is not limited in embodiments of the present disclosure.

By implementing the embodiments of the present disclosure, the terminal determines the maximum load according to the first model adopted and/or the first configuration information received from the network device, wherein the first configuration information indicates the rank constraint condition. Thus, the terminal can determine the maximum load, reducing the signaling overhead.

Please refer to FIG. 6, which is a flowchart of a method for sending model indication information provided in an embodiment of the present disclosure. As shown n FIG. 6, the method is performed by a terminal, and the method may include but is not limited to the following step;

S61, sending model indication information to the network device.

The model indication information indicates at least one of:
indication information of the first model;
indication information of a second model matched with the first model; or
indication information of a model pair of the first model and the second model matched;
wherein the second model is configured to process the quantized information to recover predicted downlink channel information similar to the downlink channel information.

In an embodiment of the present disclosure, the terminal may send the model indication information to the network device, wherein the model indication information may include the indication information of the first model.

The indication information of the first model may indicate the first model, which may inform the network device of information of the first model adopted by the terminal.

In an embodiment of the present disclosure, the terminal may send the model indication information to the network device, wherein the model indication information may include the indication information of the second model matched with the first model, wherein the second model is configured to process the quantized information to recover predicted downlink channel information similar to the downlink channel information.

The second model matched with the first model may be the CSI recovery part model of the network device. The first model and the second model may be obtained by training in the rank specific method, the rank common method, the layer specific method or the layer common method described above for example.

The indication information of the second model matched with the first model can indicate the second model, informing the network device of information of the second model that it should use, which can inform the network device to use the corresponding second model for processing, wherein the second model is matched with the first model.

In an embodiment of the present disclosure, the terminal may send the model indication information to the network device, wherein the model indication information may include indication information of a model pair of the first model and the second model matched, wherein the second model is configured to process the quantized information to recover predicted downlink channel information similar to the downlink channel information.

The indication information of the model pair of the first model and the matched second model can indicate the information of the model pair of the first model and the second model, informing the network device of the information of the first model used by the terminal and the information of the second model matched with the first model, which can inform the network device to use the corresponding second model for processing.

It should be noted that the above embodiments are not exhaustive and are only illustrative of some embodiments. The above embodiments can be implemented separately or in a combined manner. The above embodiments are only illustrative and do not serve as specific limitations on the scope of protection of the present disclosure.

In some embodiments, one or more candidate first models can be configured at the terminal, and the terminal can select one as the first model.

In other embodiments, the terminal can receive configuration information from the network device. The configuration information is used to indicate one or more candidate first models. In the case where the configuration information indicates one candidate first model, the terminal can determine that the candidate first model is the first model. In the case where the configuration information indicates multiple candidate first models, the terminal can select one of them as the first model.

It should be noted that if the configuration information from the network device only indicates one candidate first model, because there is only one candidate first model, the terminal will inevitably select the candidate first model as the first model, and the network device can know the first model selected by the terminal. Based on this, the terminal may not report the indication information of the first model.

In this embodiment or implementation, respective steps can be independently executed, arbitrarily combined, or exchanged in order without contradiction, and optional embodiments or implementations can be arbitrarily combined and can be combined with other embodiments or implementations in any way.

It should be noted that in this embodiment of the present disclosure, S61 can be implemented separately or in combination with any other step in embodiments of the present disclosure, such as in combination with S31 and/or S41 and/or S51 in embodiments of the present disclosure, which is not limited in embodiments of the present disclosure.

By implementing the embodiments of the present disclosure, the terminal sends the model indication information to the network device. Therefore, the terminal can send the model indication information, to the network device.

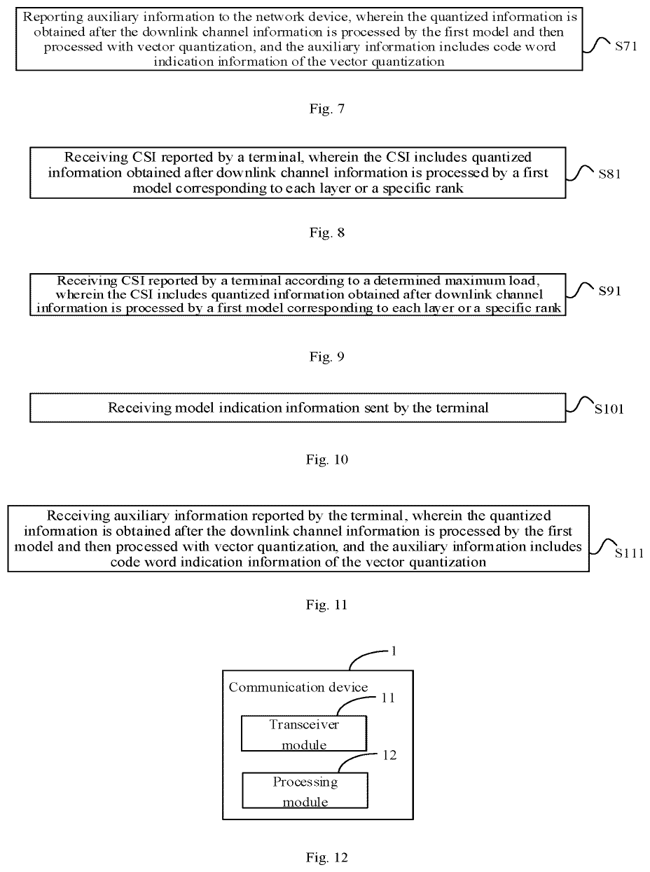

Please refer to FIG. 7, which is a flowchart of a method for reporting auxiliary information provided in an embodiment of the present disclosure. As shown in FIG. 7, the method is performed by a terminal, and the method may include but is not limited to the following step:

S71, reporting auxiliary information to the network device, wherein the quantized information is obtained after the downlink channel information is processed by the first model and then is processed with vector quantization, and the auxiliary information includes code word indication information of the vector quantization.

In an embodiment of the present disclosure, in the case that the quantized information is obtained after the downlink channel information is processed by the first model and then is processed with vector quantization, the terminal may report auxiliary information to the network device, and the auxiliary information includes code word indication information of the vector quantization.

In an embodiment of the present disclosure, the terminal may report the auxiliary information to the network device separately or simultaneously with other information, which is not specifically limited in embodiments of the present disclosure.

In an embodiment of the present disclosure, the terminal can report the auxiliary information to the network device by reusing an existing signaling or message, or by using a new signaling or message, which is not specifically limited in embodiments of the present disclosure.

In this embodiment or implementation, respective steps can be independently executed, arbitrarily combined, or exchanged in order without contradiction, and optional embodiments or implementations can be arbitrarily combined and can be combined with other embodiments or implementations in any way.

It should be noted that in this embodiment of the present disclosure, S71 can be implemented separately or in combination with any other step in embodiments of the present disclosure, such as in combination with S31 and/or 41 and/or S51 and/or in embodiments of the present disclosure, which is not limited in embodiments of the present disclosure.

By implementing the embodiments of the present disclosure, the terminal reports the auxiliary information to the network device, wherein the quantized information is obtained after the downlink channel information is processed by the first model and then processed with the vector quantization, and the auxiliary information includes the code word indication information of the vector quantization. Therefore, the terminal can report the code word indication information of the vector quantization to the network device.

Please refer to F which is a flowchart of yet another method for reporting channel status information provided in an embodiment of the present disclosure. As shown in FIG. 8, the method is performed by a network device, and the method may include but is not limited to the following step:

S81, receiving CSI reported by a terminal, wherein the CSI includes quantized information obtained after downlink channel information is processed by a first model corresponding to each layer or a specific rank.

In an embodiment of the present disclosure, the network device can receive the CSI reported by the terminal, wherein the CSI includes quantized information obtained after downlink channel information is processed by a first model corresponding to each layer or a specific rank.

In an embodiment of the present disclosure, the terminal can use the first model to process the downlink channel information to obtain the quantized information. The first model may be the CSI generation part model on the terminal side.

It can be understood that there may be many types of the first model, which are related to data used in training, training methods and basic models used.

In a possible implementation, the terminal can obtain the quantized information after processing the downlink channel information using the first model and performing vector quantization.

In another possible implementation, the terminal can directly obtain the quantized information after processing the downlink channel information using the first model, in which the first model performs vector quantization.

In an embodiment of the present disclosure, the CSI includes the quantized information obtained after the downlink channel information is processed by the first model corresponding to each layer of a specific rank.

In the CSI received by the network device from the terminal, the quantized information obtained after the downlink channel information is processed by the first model corresponding to each layer is included.

It can be understood that in the case of multiple layers, the first models corresponding to different layers may be the same or different. Based on this, the network device can receive the quantized information obtained by processing the downlink channel information with the first model corresponding to each layer and reported by the terminal.

CSI received by the network device from the terminal includes the quantized information obtained after the downlink channel information is processed by the first model corresponding to the specific rank.

It can be understood that the network device can indicate the maximum transmission rank of the uplink transmission of the terminal. In the case of rank 1, the first models corresponding to different ranks may be the same or different. The terminal can select one of the ranks as the specific rank and based on this, the network device can receive the quantized information obtained after the downlink channel information is processed by the first model corresponding to the specific rank and reported by the terminal.

In some embodiments, the network device receives model indication information sent by the terminal, wherein the model indication information indicates at least one of:
indication information of the first model;
indication information of a second model matched with the first model; or
indication information of a model pair of the first model and the second model matched;
wherein the second model is configured to process the quantized information to recover predicted downlink channel information similar to the downlink channel information.

In an embodiment of the present disclosure, the network device may receive the model indication information sent by the terminal, wherein the model indication information may include the indication information of the first model.

The indication information of the first model can indicate the first model, and the network device can determine the first model used by the terminal.

In an embodiment of the present disclosure, the network device may receive the model indication information sent by the terminal, wherein the model indication information may include indication information of the second model matched with the first model, wherein the second model is configured to process the quantized information to recover predicted downlink channel information similar to the downlink channel information.

The second model matched with the first model may be the CSI recovery part model on the network device side. The first model and the second model may be obtained by training in the rank specific method, the rank common method, the layer specific method or the layer common method described above for example.

The indication information of the second model matched with the first model can indicate the second model, and the network device can determine the second model that it should use, and further can use the second model for processing, wherein the second model is matched with the first model.

In an embodiment of the present disclosure, the network device may receive the model indication information sent by the terminal, wherein the model indication information may include indication information of a model pair of the first model and the second model matched, wherein the second model is configured to process the quantized information to recover predicted downlink channel information similar to the downlink channel information.

The indication information of the model pair of the first model and the matched second model can indicate the information of the model pair of the first model and the second model, and the network device can determine e information of the first model used by the terminal and the second model matched with the first model, and further use the second model for processing.

It should be noted that the above embodiments are not exhaustive and are only illustrative of some embodiments. The above embodiments can be implemented separately or in a combined manner. The above embodiments are only illustrative and do not serve as specific limitations on the scope of protection of the present disclosure.

In some embodiments, one or more candidate first models can be configured at the terminal, and the terminal can select one as the first model itself.

In other embodiments, the network device send configuration information to the terminal. The configuration information is used to indicate one or more candidate first models. In the case where the configuration information indicates one candidate first model, the terminal can determine that the candidate first model is the first model. In the case where the configuration information indicates multiple candidate first models, the terminal can select one of them as the first model.

It should be noted that if the configuration information of the network device only indicates one candidate first model, because there is only one candidate first model, the terminal will inevitably select the candidate first model as the first model, and the network device can know the first model selected by the terminal. Based on this, the terminal may not report the indication information of the first model.

In some embodiments, the CSI further includes at least one of:
CQI;
indication information of the first model;
indication information of the second model matched with the first model; of
indication of a model pair of the first model and the second model matched.
wherein the second model is configured to process the quantized information to recover predicted downlink channel information similar to the downlink channel information.

In an embodiment of the present disclosure, the CSI may further include RI. The terminal can determine the RI based on the constraints configured by network device and report the RI to the network device.

In an embodiment of the present disclosure, the CSI may further include CQI.

In an embodiment of the present disclosure, the CSI may further include the indication information of the first model.

The indication information of the first model can indicate the first model, and the network device can determine the first model used by the terminal.

In an embodiment of the present disclosure, the CSI may further include indication information of the second model matched with the first model, wherein the second model is configured to process the quantized information to recover predicted downlink channel information similar to the downlink channel information.

The second model matched with the first model may be the CSI recovery part model on the network device side. The first model and the second model may be obtained by training in the rank specific method, the rank common method, the layer specific method or the layer common method described above for example.

The CSI further includes the indication information of the second model matched with the first model, which can indicate the second model, and the network device can determine the second model that it should use, and further use the second model for processing, wherein the second model is matched with the first model.

In an embodiment of the present disclosure, the CSI may further include indication information of a model pair of the first model and the second model matched, wherein the second model is configured to process the quantized information to recover predicted downlink channel information similar to the downlink channel information.

The network device may receive the indication information of the model pair, and the network device may determine information of the first model used by the terminal and the information of the second model matched with the first model, and further use the second model for processing.

It should be noted that the above embodiment not exhaustive and are only illustrative of some embodiments. The above embodiments can be implemented separately or in a combined manner. The above embodiments are only illustrative and do not serve as specific limitations on the scope of protection of the present disclosure.

In some embodiments, when the terminal reports the CSI to the network device, the content of CSI may be reported as a whole, or may be split for reporting separately in multiple times.

In some embodiments, if the terminal chooses to split the content of CSI for reporting separately in multiple times, the terminal can report separately in multiple times at different moments, to achieve reporting the CSI to the network device.

In some embodiments, receiving by the network device the CSI reported by the terminal includes: receiving a first part of information and a second part of information sent by the terminal at different moments, wherein the CSI includes the first part of information and the second part of information.

In an embodiment, when the network device receives the CSI reported by the terminal, the network device may receive the first part of information and the second part of information reported by the terminal at different moments.

The CSI includes the first part information and the second part of information.

In some embodiments, receiving by the network device the first and second parts of information reported by the terminal includes: receiving the first part of information reported by the terminal using a PUSCH or a PUCCH, and receiving the second part of information reported by the terminal using the PUSCH or the PUCCH.

In an embodiment of the present disclosure, the network device may receive the first part of information reported by the terminal using the PUSCH or PUCCH, and the second part of information reported by the terminal using the PUSCH or PUCCH.

In some embodiments, receiving by the network device the first part of information and the second part of information reported by the terminal includes:
receiving the first part of information and the second part of information reported by the terminal periodically; or
receiving the first part of information and the second part of information reported by the terminal non-periodically; of
receiving the first part of information and the second part of information reported by the terminal semi-continuously.

The first part of information is associated with the second part of information following and adjacent to the first part of information.

In an embodiment of the present disclosure, the network device may receive the first part of information and the second part of information reported by the terminal periodically, wherein the first part of information is associated with the second part of information following and adjacent to the first part of information.

In an embodiment of the present disclosure, the network device may receive the first part of information and the second part of information reported by the terminal non-periodically, wherein the first part of information is associated with the second part of information following and adjacent to the first part of information.

In an embodiment of the present disclosure, the network device may receive the first part of information and the second part of information reported by the terminal semi-continuously, wherein the first part of information is associated with the second part of information following and adjacent to the first part of information.

It can be understood that the content of the first part of information reported by the terminal corresponds to the second part of information reported immediately after it, and the first part of information is associated with the second part of information reported immediately after it.

In an embodiment of the present disclosure, which first part of information is associated with the reported second part of the information can be determined through pre-defined or reported identifiers. The first part of the information corresponds to the first identifier, and the second part of the information corresponds to the second identifier. It can be reported that the first identifier is associated with the second identifier to determine the first part of the information corresponding to the second part of information.

In some embodiments, the first part of information includes at least one of:
RI;
CQI;
indication information of the first model; or
indication information of a second model matched with the first model;
the second part of information includes at least one of:
the quantized information obtained after the downlink channel information is processed by
the first model corresponding to each model;
lengths of the quantized information of all layers obtained after the downlink channel information is processed by the first models corresponding to the all layers;
quantities of code words of all layers obtained after the downlink channel information is processed by the first models corresponding to the all layer;
the quantized information obtained after the downlink channel information is processed by the first model corresponding to the specific rank; or
indication information of the first model.

In an embodiment of the present disclosure, the first part of information may include at least one of:
RI;
CQI;
indication information of the first model; or
indication information of a second model matched with the first model.

The second part of information may include at least one of:
the quantized information obtained after the downlink channel information is processed by the first model corresponding to each model;
lengths of the quantized information of all layers obtained after the downlink channel information is processed by the first models corresponding to the all layers;
quantities of code words of all layers obtained after the downlink channel information is processed by the first models corresponding to the all layer;
the quantized information obtained after the downlink channel information is processed by the first model corresponding to the specific rank; or indication information of the first model.

It should be noted that in the case that the first part of information does not include the indication information of the first model, the second part of information may include the indication information of the first model.

It should be noted that in the case that the network device only configures one first model for the terminal, the first part of information and the second part of information may not include the indication information of the first model.

In some embodiments, the first model and the second model are obtained by training according to a corresponding layer; or the first model and the second model are obtained by training according to a corresponding rank.

In an embodiment of the present disclosure, the first model and the second model are obtained by training according to a corresponding layer, wherein the first model and the second model may be obtained by training in a layer specific manner, or may be obtained by training in a layer common manner.

In an embodiment of the present disclosure, the first model and the second model are obtained by training according to a corresponding rank, wherein the first model and the second model may be obtained by training in a rank specific manner, or may be obtained by training in a layer common manner.

In an embodiment of the present disclosure, the first model and the second model may be obtained by training in a layer specific manner, or may be obtained by training in a layer common manner.

When the first model and the second model are obtained by training in a layer specific, manner, a bilateral model containing the first model and the second model can be obtained for each layer.

When the first model and the second model are obtained by training in a layer common manner, only one bilateral model containing the first model and the second model can be obtained for all layers.

In an embodiment of the present disclosure, if the first model and the second model are obtained by training according to the corresponding layer, the first part of information includes at least one of:
RI;
CQI;
indication information of the first model;
indication information of the second model matched with the first model;
a length of the quantized information obtained after the downlink channel information is processed by the first model corresponding to each layer; or
a quantity of code words obtained after the downlink channel information is processed by the first model corresponding to each layer.

The second part of information includes the quantized information obtained after the downlink channel information is processed by the first model corresponding to each layer.

In an embodiment of the present disclosure, the first model and the second model may be obtained by training in a rank specific manner, or may be obtained by training in a rank common manner.

When the first model and the second model are obtained by training in a rank specific manner, a bilateral model containing the first model and the second model can be obtained for each rank.

When the first model and the second model are obtained by training in a rank common manner, only one bilateral model containing the first model and the second model can be obtained for all ranks.

In an embodiment of the present disclosure, if the first model and the second model are obtained by training according to the corresponding rank, the first part of information includes at least one of:
RI;
CQI
indication information of the first model;
indication information of the second model matched with the first model;
a length of the quantized information obtained after the downlink channel information is processed by the first model corresponding to the specific rank; or
a quantity of code words obtained after the downlink channel information is processed by the first model corresponding to the specific rank.

The second part of information includes the quantized information obtained after the downlink channel information is processed by the first model corresponding to the specific rank.

In some embodiments, data input to the first model may include two types, one is a precoding matrix in a space-frequency domain, and the other is a precoding matrix in an angle-time delay domain.

No matter what type of data is input to the first model, the information included in the first part model and the second part model may be the same as the content included in the first part of information and the second part of information described in some embodiments above.

It can be understood that in an embodiment of the present disclosure, the first part of the information includes the indication information of the first model, and the length of the quantized information obtained after the downlink channel information is processed by the first model corresponding to each layer or each rank can also be directly determined. The terminal may not need to report the length of the quantized information obtained after the downlink channel information is processed by the first model corresponding to each layer or each rank, thus reducing the feedback overhead of the terminal.

In some embodiments, data input to the first model includes a precoding matrix in a space-frequency domain, or a precoding matrix in an angle-time delay domain, wherein in a case where the data input to the first model is the precoding matrix in the angle-time delay domain, the second part of information further includes indication information of spatial and frequency domain basis vectors selected by the terminal.

In an embodiment of the present disclosure, data input to the first model may include two types, one is a precoding matrix in a space-frequency domain, and the other is a precoding matrix in an angle-time delay domain.

In the case where the data input to the first model is the precoding matrix in the space-frequency domain, the information included in the first part model and the second part model may be the same as the content included in the first part of information and the second part of information described in some embodiments above.

In the case where the data input to the first model is the precoding matrix in the angle-time delay domain, the information included in the first part model may be the same as the content included in the first part of information described in some embodiments above, and the second part of information may also include indication information of the spatial and frequency domain basis vectors selected by the terminal in addition to the content described in some embodiments above.

It can be understood that the terminal can determine the indication information of the spatial and frequency domain basis vectors based on the configuration of the network device. In this case, the terminal does not need to report the indication information of the spatial and frequency domain basis vectors. If the terminal selects the indication information of the spatial and frequency domain basis vectors, the terminal needs to report the indication information of the spatial and frequency domain basis vectors.

In some embodiments, the CSI further includes code word indication information of vector quantization, wherein the quantized information is obtained after the downlink channel information is processed by the first model and then is processed with the vector quantization.

In an embodiment of the present disclosure, in the case that the quantized information is obtained after the downlink channel information is processed by the first model and then is processed with the vector quantization, the CSI may further include code word indication information of the vector quantization.

In some embodiments, the network device receives auxiliary information reported by the terminal, wherein the quantized information is obtained after the downlink channel information is processed by the first model and then is processed with vector quantization, and the auxiliary information includes code word indication information of the vector quantization.

In an embodiment of the present disclosure, in the case that the quantized information is obtained after the downlink channel information is processed by the first model and then is processed with vector quantization, the network device may receive auxiliary information reported by the terminal, and the auxiliary information includes code word indication information of the vector quantization.

In this implementation or embodiment, respective steps can be independently executed, arbitrarily combined, or exchanged in order without contradiction, and optional implementations or embodiments can be arbitrarily combined and can be combined with other embodiments or implementations in any way.

By implementing the embodiments of the present disclosure, the network device receives the CSI reported by the terminal, wherein the CSI includes the quantized information obtained after the downlink channel information is processed by the first model corresponding to each layer or specific rank. Thus, the network device can receive the CSI including the quantized information obtained after the downlink channel information is processed by the first model corresponding to each layer or specific rank and reported by the terminal, so that the network accurate CSI.

Please refer to FIG. 9, which is a flowchart of yet another method for reporting channel status information provided in an embodiment of the present disclosure. As shown in FIG. 9, the method is performed by a network device, and the method may include but is not limited to the following step:

S91, receiving SCI reported by a terminal according to a determined maximum load, wherein the CSI includes quantized information obtained after downlink channel information is processed by a first model corresponding to each layer or a specific rank.

In an embodiment of the present disclosure, the network device may receive the CSI reported by the terminal according to the determined maximum load.

The relevant description of the network device receiving CSI reported by the terminal can be found in the above embodiments, which will not be repeated here.

The terminal can determine the maximum load based on the configuration of the network device, or the terminal can also determine the maximum load based on other information, which is not specifically limited in embodiments of the present disclosure.

In some embodiments, the terminal determines the maximum loud according to the first model adopted and/or first configuration information received from the network device, wherein the first configuration information indicates a rank constraint condition.

In an embodiment of the present disclosure, the terminal may determine the maximum load according to the adopted first model.

In an embodiment of the present disclosure, the terminal may determine the maximum load according to the first configuration information received from the network device.

The first configuration information is used to indicate a rank condition. The terminal may determine the maximum load according to the rank constraint condition sent by the network device.

It can be understood that the terminal determines the maximum load according to the first model adopted and/or the first configuration information received from the network device, so that the network device does not need to configure the maximum load for the terminal, which can reduce signaling overhead.

In an embodiment of the present disclosure, the network device may send the first configuration information to the terminal, wherein the first configuration information is used for the terminal to, determine the maximum load, and the first configuration information indicates the rank constraint condition.

In an embodiment of the present disclosure, the network device may send the first configuration information to the terminal, wherein the first configuration information is used for the terminal to determine the maximum load, and the first configuration information indicates the rank constraint condition. Therefore, the terminal can determine the maximum load according to the rank constraint condition indicated by the first configuration information.

In an embodiment of the present disclosure, the terminal reports the CSI to the network device according to the determined maximum load. In the case where CSI is less than the maximum load, the remaining part is filled with zeros and then the CSI is reported to the network device.

In the case where CSI is equal to the maximum load, CSI can be directly reported to the network device.

In the case where CSI is greater than the maximum load, the whole CSI can be discarded, or some information in CSI can be discarded and the remaining information of CSI can be reported to the network device, wherein some information in CSI can be discarded according to a CSI discarding criteria or method.

In this embodiment or implementation, respective steps can be independently executed arbitrarily combined, or exchanged in order without contradiction, and optional embodiments of implementations can be arbitrarily combined and can be combined with other embodiments or implementations in any way.

It should be noted that in this embodiment of the present disclosure, S91 can be implemented separately or in combination with any other step in embodiments of the present disclosure, such as in combination with S81 in embodiments of the present disclosure, which is not limited in embodiments of the present disclosure.

By implementing the embodiments of the present disclosure, the network device receives the CSI reported by the terminal according to the determined maximum load, wherein the CSI includes the quantized information obtained after the downlink channel information is processed by the first model corresponding to each layer or a specific rank. Thus, the network device can receive the CSI reported by the terminal according to the determined maximum load, which includes the quantized information obtained after processing the downlink channel information by the first model corresponding to each layer or a specific rank, so that the network obtain accurate CSI

Please refer to FIG. 10, which is a flowchart of another method for sending model indication information provided in an embodiment of the present disclosure in FIG. 10, the method is performed by a network device, and the method may include but is not limited to the following step:

S101, receiving model indication information sent by the terminal.

The model indication information indicates at least one of:
indication information of the first model:
indication information of a second model matched with the first model; or
indication information of a model pair of the first model and the second model matched;
wherein the second model is configured to process the quantized information to recover predicted downlink channel information similar to the downlink channel information.

In an embodiment of the present disclosure, the network device may receive the model indication information sent by the terminal, wherein the model indication information may include the indication information of the first model.

The indication information of the first model may indicate the first model, and the network device can determine the first model adopted by the terminal.

In an embodiment of the present disclosure, the network device may receive the model indication information sent by the terminal, wherein the model indication information may include the indication information of the second model matched with the first model, wherein the second model is configured to process the quantized information to recover predicted downlink channel information similar to the downlink channel information.

The second model matched with the first model may be the CSI recovery part model of the network device. The first model and the second model may be obtained by training in the rank specific method, the rank common method, the layer specific method or the layer common method described above for example.

The indication information of the second model matched with the first model can indicate the second model, and the network device can determine the second model that it should use, and further use the second model for processing, wherein the second model is matched with the first model.

In an embodiment of the present disclosure, the network device may receive the model indication information sent by the terminal, wherein the model indication information may include indication information of a model pair of the first model and the second model matched, wherein the second model is configured to process the quantized information to recover predicted downlink channel information similar to the downlink channel information.

The indication information of the model pair of the first model and the matched second model can indicate the information of the model pair of the first model and the second model, and the network device can determine the information of the first model used by the terminal and the second model matched with the first model, and further use the second model for processing.

It should be noted that the above embodiments are not exhaustive and are only illustrative of some embodiments. The above embodiments can be implemented separately or in a combined manner. The above embodiments a only illustrative and do not serve as specific limitations on the scope of protection of the present disclosure.

In some embodiments, one or more candidate first models can be configured at the terminal, and the terminal can select one as the first model.

In other embodiments, the terminal can receive configuration information from the network device. The configuration information is used to indicate one or more candidate first models. In the case where the configuration information indicates one candidate first model, the terminal can determine that the candidate first model is the first model. In the case where the configuration information indicates multiple candidate first models, the terminal can select one of them as the first model.

It should be noted that if the configuration information from the network device only indicates one candidate first model, because there is only one candidate first model, the terminal will inevitably select the candidate first model as the first model, and the network device can know the first model selected by the terminal. Based on this, the terminal may not report the indication information of the first model.

In this embodiment or implementation, respective steps can be independently executed, arbitrarily combined, or exchanged in order without contradiction, and optional embodiments or implementations can be arbitrarily combined and can be combined with other embodiments or implementations in any way.

It should be noted that in this embodiment of the present disclosure, S101 can be implemented separately or in combination with any other step in embodiments of the present disclosure, such as in combination with S81 and/or S91 in embodiments of the present disclosure, which is not limited in embodiments of the present disclosure.

By implementing the embodiments of the present disclosure, the network device receives the model indication information sent by the terminal. Therefore, the terminal can send the model indication information to the network device.

Please refer to FIG. 11, which is a flowchart of another method for reporting auxiliary information provided in an embodiment of the present disclosure. As shown in FIG. 11, the method is performed by a network device, and the method may include but is not limited to the following step:

S111, receiving auxiliary information reported by the terminal, wherein the quantized information is obtained after the downlink channel information is processed by the first model and then is processed with vector quantization, and the auxiliary information includes code word indication information of the vector quantization.

In an embodiment of the present disclosure, in the case that the quantized information is obtained after the downlink channel information is processed by the first model and then is processed with vector quantization, the network device may receive the auxiliary information reported by the terminal, and the auxiliary information includes code word indication information of the vector quantization.

In an embodiment of the present disclosure, the network device may receive the auxiliary information reported by the terminal separately or simultaneously with other information, which is not specifically limited in embodiments of the present disclosure.

In an embodiment of the present disclosure, the network device may receive the auxiliary information reported by the terminal by reusing an existing signaling or message, or by using a new signaling or message, which is not specifically limited in embodiments of the present disclosure.

In this embodiment or implementation, respective steps can be independently executed, arbitrarily combined, or exchanged in order without contradiction, and optional embodiments or implementations can be arbitrarily combined and can be combined with other embodiments or implementations in any way.

It should be noted that in this embodiment of the present disclosure, S111 can be implemented separately or in combination with any other step in embodiments of the present disclosure, such as in combination with S81 and/or S91 and/or S101 in embodiments of the present disclosure, which is not limited in embodiments of the present disclosure.

By implementing the embodiments of the present disclosure, the network device receives the auxiliary information reported by the terminal, wherein the quantized information is obtained after the downlink channel information is processed by the first model and then processed with the vector quantization, and the auxiliary information includes the code word indication information of the vector quantization. Therefore, the network device can receive the code word indication information of the vector quantization reported by the terminal.

To facilitate the understanding of the embodiments of the disclosure, take the first model as the CSI generation part model and the second model as the CSI recovery part model as an example to illustrate the method for reporting channel status information provided by the embodiments of the disclosure.

In embodiments of the present disclosure, a method for determining the maximum CSI load size and the content of CSI reported to network device is proposed for compressing CSI feedback in a bilateral AI/ML model. This is used for the network device B) to obtain accurate CSI feedback information as input information for the CSI recovery model on the &NB side.

In some embodiments, the maximum CSI load size reported by the terminal (also known as the maximum load, the same below) is determined as follows:

The terminal can determine the maximum load based on the CSI generation part AI/ML Model (the CSI generation part model) adopted by the terminal and/or the rank constraint condition configured by the network device.

In some embodiments, the CSI generation part AI/MI Model is determined as follows:
The CSI generation part AI/ML model used by the terminal is determined by the following Option1 and/or Option2. Different CSI reporting methods are provided for Option1 and Option2, respectively.
Option1: one or more CSI generation part AI/ML models are configured by the network device, and the terminal determines one CSI generation part AI/ML model from them,
Option1-1: CSI reporting is divided into two parts: Part 1 (first part of information) and Part 2 (second part of information) (the data input into the CSI generation part AI/ML model is Alt1, i.e., the precoding matrix in the space-frequency domain).

Alt1-1: Part 1 (first part of information) includes one or more of the following: RI, COL indication information of CSI generation part AI/ML. Model/CSI recovery part AI/ML Model (if only one CSI generation part AI/ML is configured, the UE (terminal) does not need to report AI/ML Model indication information); Part 2 (second part of information) includes: the quantized information output by the CSI generation part AI/ML Model corresponding to each layer (for layer specific/common model), or the quantized information output by the CSI generation part AI/ML Model corresponding to a certain rank (for rank specific/common model).

Optionally, the indication information of the CSI generation part AI/ML model is put in Part 2 for reporting.

Alt1-2 (Layer specific/common model): Part 1 includes: RI, CQI, CSI generation part AI/ML Model/CSI recovery model, the length of quantized information output by the CSI generation part AI/ML Model corresponding to each layer or the number of code words output by the CSI generation AI/ML. Model (UE indicates AI/ML model information to NW), and some candidate parameter values configured by the DE based on network device. Part 2 includes the quantized information generated by the CSI generation AI/ML, model corresponding to each layer.

Alt1-3 (Rank common/specific): Part 1 contains RI, COL, CSI generation model/CSI recovery model, the information length corresponding to rank=v or the information length that has been determined based on the configured model. Part 2 contains the quantized information after compressing rank=v.

It should be noted that in the case where the data input into the CSI generation part model is Alt2, which is the precoding matrix in the angle-time delay domain, Part 2 may also include indication information of spatial and frequency domain basis vectors.

It should be noted that if the vector quantization information is not included in the model training, the code word indication information of vector quantization can be reported through Part 1 and Part 2 mentioned above, or can be reported separately from Part 1 and Part 2 as auxiliary information.

Optional-2: CSI is not split, that is, CSI is reported as a whole. If the reported CSI is less than the maximum CSI load configured by the network device, the remaining part will be filled with. When the CSI is reported as a whole, the CSI includes: CQI, the quantized information output by the CSI generation AI/ML Model corresponding to each layer or the quantized information output by the CSI generation AI/ML. Model corresponding to each rank. The RI information is determined by the constraints configured by the network device.

Option1-3; The contents of Part 1 and Part 2 contained in CSI are reported through PUCCH and/or PUSCH at different reporting moments, or Part 1 and Part 2 are carried on PUCCH and PUSCH respectively for reporting. The time-domain behavior of the reporting may be periodic, semi-persistent, or non-periodic. Note that the content of reported Part 2 corresponds to the content of its previous and nearest reported Part 1, or which reported Part 1 corresponds to the reported Part 2 is determined through pre-defined or reported ID association.

Optionally, information of RI, CQI, and quantized information output by the CSI generation part AI/ML Model is sent to the network device through two CSI reports.

Option2: the CSI generation AI/ML Model is selected and reported by the terminal (considering multiple models already deployed in the UE).

Option2-1: indication information of the CSI generation AI/ML Model is, independently indicated and reported by the terminal.

The indication information may be information indicating the function ID or model ID of the AI/ML model.

Option2-2: indication information of the CSI generation AI/MI, Model is jointly reported with other information of CSI, such as placing the indication information of the CSI generation AI/ML Model in the above-mentioned CSI Part 1 or Part 2 for being reported to the network device.

In an illustrative embodiment, it is assumed that the network device (gNB) instructs the terminal (UE) to adopt a CSI generation part AI/ML model and maximum transmission rank through signaling such as RRC, MAC-CE, or DCI. UE can determine the maximum load length for uplink transmission based on the configuration information. Optionally, gNB directly indicates the maximum Joad length and/or maximum transmission rank for UE uplink transmission through signaling.

In some embodiments, UB reports CSI based on the parameter information configured by &NB and estimated channel information. CSI reporting is divided into two parts: Part 1 (first part of information) and Part 2 (second part of information):

Part 1 includes: RI, COL, indication information of CSI generation part AI/ML Model/CSI recovery part AI/ML. Model. The indication information of RI and CQI is the same as the traditional codebook based CSI reporting indication method. The AI/ML model selected by the UE is indicated through

$$⌈ {log}_{2}^{X} ⌉$$

bits, where X represents the number of AI/ML models deployed on the UE side.

Part 2 includes: for the Layer specific/common model, Part 2 contains the quantized information output by the CSI generation part AI/ML model corresponding to each layer; For the Rank specific/common model, Part 2 contains the quantized information output by the CSI generation part AI/ML model.

Due to the inclusion of the CSI generation part AI/ML Model in Part 1, the length of compressed quantized information corresponding to each layer or rank is also determined, eliminating the need for UE to indicate the length of this information in feedback, thereby reducing UE feedback overhead.

In some embodiments, the contents of Part 1 and Part 2 included in CSI are reported through PUCCH and/or PUSCH at different reporting moments:

The RI and CQI information contained in Part 1 are reported through PUCCH or PUSCH at time T.

The quantized information output by the CSI generation part AI/ML Model included in Part 2 is reported through PUCCH or PUSCH at time T′, where Tx≠T′. The quantized information output by the CSI generation part AI/ML Model may be the quantized information corresponding to each transmission layer or a certain transmission rank.

In an illustrative embodiment, it is assumed that X=4 corresponding Al based CSI compression feedback bilateral models under different scenarios and configurations are deployed on the terminal (UE) side. The UE selects one of the bilateral CSI models based on the current channel conditions and the sub-band size or number of CSI-RS ports configured by the network device.

UE reports the indication information of the selected model to the network device (gNB) through non-periodic CSI reporting. The indication information size is

$$⌈ {log}_{2}^{X} ⌉ = 2$$

bits. Alternatively, the indication information can be reported to gNB together with Part 1 as described in Embodiment 1 above.

Since the UB indicates the selected AI/ML model to the gNB, and the channel length corresponding to each AI/ML, model is fixed, then when the rank is certain, this indirectly reflects the load size required for UE feedback CSI. If UE and gNB negotiate to predefine the CSI feedback load size based on the model, there is no need for gNB to separately configure the CSI load size, thereby reducing the overhead of gNB configuration signaling.

In this embodiment of the present disclosure, determining the CSI load size or CSI reporting size based on the AI/ML model adopted by the UE can reduce configuration signaling overhead or UE feedback overhead.

In the above embodiments provided in this disclosure, the methods provided in this disclosure are introduced from the perspectives of the terminal and the network device, respectively.

Please refer to FIG. 12, which is a block diagram of a communication device 1 provided in an embodiment of the present disclosure. The communication device 1 shown in FIG. 12 may include a transceiver module 11 and a processing module. The transceiver module may include a sending module and/or a receiving module. The sending module is configured to implement the sending function, and the receiving module is configured to implement the receiving function. The transceiver module can implement the sending function and/or the receiving function.

The communication device 1 may be a terminal, or a device within the terminal, or a device that can be used in conjunction with the terminal. Alternatively, the communication device 1 may be a network device, or a device within the network device, or a device that can be used in conjunction with the network device,
The communication device 1 is arranged on the terminal side;
The device includes the transceiver module 11.

The transceiver module 11 is configured to report channel status information (CSI) to a network device, wherein the CSI includes quantized information obtained alter downlink channel information is processed by a first model corresponding to each layer or a specific rank.

In some embodiments, the transceiver module 11 is further configured to report the CSI to the network device according to a determined maximum load.

In some embodiments, the device includes the processing module 12.

The processing module 12 is configured to determine the maximum load according to the first model adopted and/or first configuration information received from the network device, wherein the first configuration information indicates a rank constraint condition.

In some embodiments, the transceiver module 11 is further configured to receive second configuration information sent by the network device, wherein the second configuration information indicates a plurality of candidate first models; and the processing module 12 is further configured to determine one of the plurality of candidate first models as the first model adopted.

In some embodiments, the CSI further includes at least one of
a rank indication (RI);
a channel quality indicator (CQD);
indication information of the first model;
indication information of a second model matched with the first model; or
indication information of a model pair of the first model and the second model matched;
wherein the second model is configured to process the quantized information to recover predicted downlink channel information similar to the downlink channel information.

In some embodiments, the transceiver module 11 is further configured to send model indication information to the network device, wherein the model indication information indicates at least one of:
indication information of the first model;
indication information of a second model matched with the first model; or
indication information of a model pair of the first model and the second model matched;
wherein the second model is configured to process the quantized information to recover predicted downlink channel information similar to the downlink channel information.

In some embodiment the transceiver module 11 is further configured to report a first part of information and a second part of information to the network device at different moments, wherein the CSI includes the first part of information and the second part of information.

In some embodiments, the transceiver module 11 is further configured to report the first part of information to the network device using a PUSCH or a PUCCH; and report the second part of information to the network device using a PUSCH or a PUCCH.

In some embodiments, the transceiver module 11 is further configured to: report the first part of information and the second part of information to the network device periodically; or
report the first part of information and the second part of information to the network device non-periodically; or
report the first part of information and the second part of information to the network device semi-continuously;
wherein the first part of information is associated with the second part of information following and adjacent to the first part of information.

In some embodiments, the first part of information includes at least one of:
RI;
CQI;
indication information first model; or
indication information of a second model matched with the first model;
the second part of information includes at least one of:
the quantized information obtained after the downlink channel information is processed by the first model corresponding to each model;
lengths of the quantized information of all layers obtained after the downlink channel information is processed by the first models corresponding to the all layers;
quantities of code words of all layers obtained after the downlink channel information is processed by the first models corresponding to the all layer;
the quantized information obtained after the downlink channel information is processed by the first model corresponding to the specific rank; or
indication information of the first model.

In some embodiments, the first model and the second model are obtained by training according to a corresponding layer, or the first model and the second model are obtained by training according to a corresponding rank.

In some embodiments, data input to the first model includes a precoding matrix in a space-frequency domain, or a precoding matrix in an angle-time delay domain, wherein in a case where the data input to the first model is the preceding matrix in the angle-time delay domain, the second part of information further includes indication information of spatial and frequency domain basis vectors selected by the terminal.

In some embodiments, the CSI further includes code word indication information of vector quantization, wherein the quantized information is obtained after the downlink channel information is processed by the first model and then is processed with the vector quantization.

In some embodiments, the transceiver module 11 is further configured to report auxiliary information to the network device, wherein the quantized information is obtained after the downlink channel information is processed by the first model and then is processed with vector quantization, and the auxiliary information includes code word indication information of the vector quantization.

The communication device 1 is arranged on the network device side:

The device includes the transceiver module 11.

The transceiver module 11 is configured to receive CSI reported by a terminal, wherein the CSI includes quantized information obtained after downlink channel information is processed by a first model corresponding to each layer or a specific rank.

In some embodiments, the transceiver module 11 is further configured to receive the CSI reported by the terminal according to a determined maximum load.

In some embodiments, the transceiver module 11 is further configured to send first configuration information to the terminal, wherein the first configuration information is used for the terminal to determine the maximum load, and the first configuration information indicates a rank constraint condition:

In some embodiments, the CSI further includes at least one of:
rank indication (RI);
a channel quality indicator (CQD);
indication information of the first model;
indication information of a second model matched with the first model; or
indication information of a model pair of the first model and the second model matched;
wherein the second model is configured to process the quantized information to recover
predicted downlink channel information similar to the downlink channel information.

In some embodiments, the transceiver module 11 is further configured to receive model indication information sent by the terminal, wherein the model indication information indicates at least one of:
indication information of the first model;
indication information of a second model matched with the first model; or
indication information of a model pair of the first model and the second model matched;
wherein the second model is configured to process the quantized information to recover predicted downlink channel information similar to the downlink channel information.

In some embodiments, the transceiver module 11 is further configured to receive a first part of information and a second part of information reported by the terminal at different moments, wherein the CSI includes the first part of information and the second part of information.

In some embodiments, transceiver module 11 is further configured to: receive the first part of information reported by the terminal using a PUSCH or a PUCCH; and receive the second part of information reported by the terminal using a PUSCH or a PUCCH.

In some embodiments, the transceiver module 11 is further configured to: receive the first part of information and the second part of information reported by the terminal periodically; or
receive the first part of information and the second part of information reported by the terminal non-periodically; or
receive the first part of information and the second part of information reported by the terminal semi-continuously;
wherein the first part of information is associated with the second part of information following and adjacent to the first part of information.

In some embodiments, the first part of information includes at least one of:
RI;
CQI;
indication information of the first model; or
indication information of a second model matched with the first model;
the second part of information includes at least one of;
the quantized information obtained after the downlink channel information is processed by
the first model corresponding to each model;
the quantized information obtained after the downlink channel information is processed by the first model corresponding to the specific rank; or
indication information of the first model.

In some embodiments, the first model and the second model are obtained by training according to a corresponding layer, or the first model and the second model are obtained by training according to a corresponding rank.

In some embodiments, data input to the first model includes a precoding matrix in a space-frequency domain, or a precoding matrix in an angle-time delay domain, wherein in a case where the data input to the first model is the precoding matrix in the angle-time delay domain, the second part of information further includes indication information of spatial and frequency domain basis vectors selected by the terminal.

In some embodiments, the CSI further includes code word indication information of vector quantization, wherein the quantized information is obtained after the downlink channel information is processed by the first model and then is processed with the vector quantization.

In some embodiments, the transceiver module 11 is further configured to receive auxiliary information reported by the terminal, wherein the auxiliary information includes code word indication information of vector quantization, and the quantized information is obtained after the downlink channel information is processed by the first model and then is processed with the vector quantization.

Regarding the communication device 1 in the above embodiments, the specific ways in which each module performs operations have been described in detail in the relevant embodiments of the method, and will not be elaborated here.

The communication device 1 provided in the above embodiments of the present disclosure achieves the same or similar beneficial effects as the methods for reporting channel status information provided in some of the above embodiments, not be repeated here.

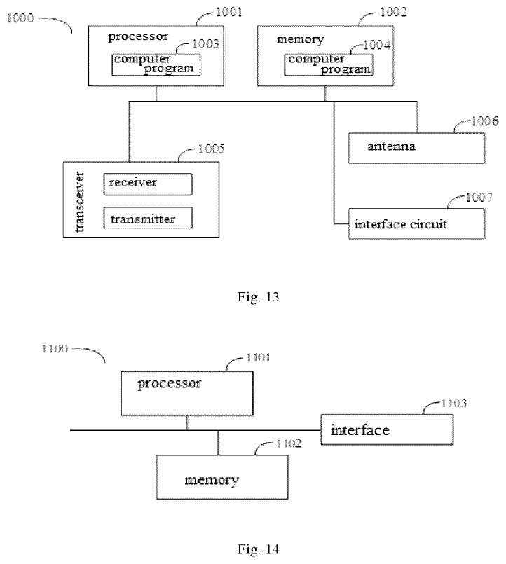

Please refer to FIG. 13, which is a block diagram of another communication dev ice 1000 provided in an embodiment of the present disclosure. The communication device 1000 may be a network device or a terminal, or a chip, chip system, or processor that supports the network device to implement the above methods, or a chip, chip system, or processor that supports the terminal to implement the above methods. The communication device 1000 can be used to implement the method described in the above method embodiments. For details, please refer to the description in the above method embodiments.

The communication device 1000 may include one or more processors 1001. The processor 1001 may be a general-purpose processor or dedicated processor, etc. For example, it may be a baseband processor or a central processor. The baseband processor can be used to proc ss communication protocols and communication data, while the central processor can be used to control communication devices (such as network side devices, baseband chips, terminals, terminal chips, DU or CU, etc.), execute computer programs, and process data from computer programs.

Optionally, the communication device 1000 may also include one or more memories 1002 on which computer programs 1004 may be stored. The processor 1001 executes the computer programs 1004 to enable the communication device 1000 to perform the methods described in the above method embodiments. Optionally, the memory 1002 may also store data. The communication device 1000 and the memory 1002 can be set separately or integrated together.

Optionally, the communication device 1000 may also include a transceiver 1005 and an antenna 1006. The transceiver 1005 can be referred to as a transceiver unit, transceiver machine, or transceiver circuit, etc., used to implement the sending and receiving function. The transceiver 1005 may include a receiver and a transmitter, where the receiver can be referred to as a receiver machine or receiving circuit, etc., used to implement the receiving function; the transmitter can be referred to as a transmitter machine or a transmission circuit, etc., used to implement the sending function.

Optionally, the communication device 1000 may also include one or more interface circuits 1007. The interface circuit 1007 is configured to receive code instructions and transmit them to processor 1001. The processor 1001 executes the code instructions to cause the communication device 1000 to perform the method described in the above method embodiments.

The communication device 1000 is the terminal: the transceiver 1005 is configured to execute S31 in FIG. 3; or execute 841 in execute S51 in FIG. 5; or execute S61 in FIG. 6; or execute S71 in FIG. 7; the processor 1001 is configured to execute S51 in FIG. 5.

The communication device 1000 is the network device: the transceiver 1005 is configured to execute S81 in FIG. 8; or execute S91 in FIG. 9; or execute S101 in FIG. 10; or execute S11) in FIG. 11.

In an implementation, the processor 1001 may include a transceiver for implementing receiving and sending functions. For example, the transceiver may be a transceiver circuit, or an interface, or an interface circuit. The transceiver circuit, interface, or interface circuit used to implement the receiving and sending function be separate or integrated together. The above-mentioned transceiver circuit, interface or interface circuit can be used for reading and writing code/data, or the above-mentioned transceiver circuit, interface or interface circuit can be used for signal transmission or transfer.

In an implementation, the processor 1001 may store computer program, which when run on the processor 1001, enables the communication device 1000 to perform the method described in the above method embodiments. The computer program 1003 may be fixed in the processor 1001, in which case the processor 1001 may be implemented by hardware.

In an implementation, the communication device 1000 may include a circuit that can perform the functions of sending, receiving or communicating as described in the aforementioned method embodiments. The processor and transceiver described in this disclosure can be implemented on integrated circuits (IC's), analog ICs, radio frequency integrated circuits (RFICs), mixed signal ICs, application specific integrated circuits (ASICS), printed circuit boards (PCBs), electronic devices, etc. The processor and transceiver can also be manufactured using various IC process technologies, such as complementary metal oxide semiconductor (CMOS), n-type metal oxide semiconductor (NMOS), positive channel metal oxide semiconductor (PMOS), bipolar junction transistor (BJT), bipolar CMOS, silicon germanium (SiGe), gallium arsenide (GaAs), etc.

The communication device described in the above embodiments may be a network device, or a terminal, but the scope of the communication device described in this disclosure is not limited to this, and the Structure of the communication device may not be limited by FIG. 13. The communication device may be a standalone device or a part of a larger device. For example, the communication device may be:
(1) Independent integrated circuit IC, or chip, or chip system or subsystem;
(2) A set of one or more ICs, optionally including storage components for storing data and computer programs;
(3) ASIC, such as modems;
(4) Modules that can be embedded in other devices;
(5) Receiver, terminal device, intelligent terminal device, cellular phone, wireless device, handheld device, mobile unit, vehicle-mounted device, network device, cloud device, artificial intelligence device, etc;
(6) Others and so on.

For the case where the communication device may be a chip or chip system, please refer to FIG. 14, which is a block diagram of a chip provided in an embodiment of the present disclosure.

The chip 1100 includes a processor 1101 and an interface 1103. The number of the processor 1101 may be one or more, and the number of the interface 1103 may be multiple.

For the case where the chip is configured to implement the functions of the terminal in embodiments of the present disclosure:

The interface 1103 is configured to receive code instructions and transmit the code instructions to the processor.

The processor 1101 is configured to run the code instructions to implement the method for reporting channel status information described in some of the embodiments above.

For the case where the chip is configured to implement the functions of the network device in embodiments of the present disclosure:

The interface 1103 is configured to receive code instructions and transmit the code instructions to the processor.

The processor 1101 is configured to run the code instructions to implement the method for reporting channel status information described in some of the embodiments above.

Optionally, the chip 1100 further includes a memory 1102, for storing necessary computer programs and data.

Technicians in this field can also understand that various illustrative logical blocks and steps listed in the embodiments of the present disclosure can be implemented through electronic hardware, computer software, or a combination of both. Whether such functionality is implemented through hardware or software depends on the specific application and the design requirements of the entire syst. Technicians in this field can use various methods to implement the described functions for each specific application, but such implementation should not be understood as exceeding the scope of protection of the disclosed embodiments.

An embodiment of the present disclosure also provides a system for reporting channel status information. The system includes a communication device as a terminal and a communication device as a network device in the aforementioned embodiment of FIG. 12, or the system includes a communication device as terminal and a communication device as a network device in the aforementioned embodiment of FIG. 13.

The present disclosure also provides a readable storage medium storing instructions that, when executed by a computer, implement the functions of any of the method embodiments described above.

The present disclosure also provides a computer program product that, when executed by a computer, implements the functions of a of the method embodiments described abo e.

In the above embodiments, it can be fully or partially implemented through software, hardware, firmware, or any combination thereof. When implemented using software, it can be fully or partially implemented in the form of a computer program product. The computer program product includes one or more computer programs. When loading and executing the computer program on a computer, all or part of the process or function described in embodiments of the present disclosure is generated. The computer may be a general-purpose computer, a specialized computer, a comp der network, or other programmable device. The computer program can be stored in a computer-readable storage medium or transmitted from one computer-readable storage medium to another. For example, the computer program can be transmitted from a website site, computer, server, or data center to another website sit computer, server, or data center via wired (such as coaxial cable, fiber optic, digital subscriber line (DSL)) or wireless (such as infrared, wireless, microwave, etc.) n's. The computer-readable storage medium can be any available medium that a computer can access, or a data storage device such as a server or data center that integrates one or more available media. The available media can be magnetic media (such as floppy disks, hard disks, magnetic tapes), optical media (such as high-density digital video discs (DVDs), or semiconductor media (such as solid state disks (SSDs)).

Those skilled in the art can understand that the first, second, and other numerical numbers mentioned in this disclosure are only for the convenience of description and are not intended to limit the scope of the disclosed embodiments, but also indicate the order of occurrence.

“At least one” in the present disclosure can also be described as one or more, and “multiple” can be two, three, four, or more, without limitation in this disclosure. In embodiments of the present disclosure, for a type of technical feature, the technical features in the type of technical feature are distinguished by “first”, “second”, “third”, “A”, “B”, “C”, and “D”, etc. The technical features described by first “first”, “second”, “third”, “A”, “B”, “C”, and “D” have no order of priority or size.

Depending on the context, the words “if” and “upon” used here can be interpreted as “when” or “in the case where” or “in response to determining”.

The correspondence relationships shown in each table in this disclosure can be configured or predefined. The values of the information in each table are only examples and can be configured as other values, which are not limited by this disclosure. When configuring the correspondence between information and various parameters, it is not necessarily required to configure all the correspondence relationships shown in each table. For example, in the table disclosed herein, the correspondence relationship shown in certain rows may not be configured. For another example, appropriate deformation adjustments can be made based on the above table, such as splitting, merging, and so on. The names of the parameters shown in titles in the above tables can also be other names that the communication device can understand, and the values or representations of the parameters can also be other values or representations that the communication device can understand. The above tables can also be implemented using other data structures, such as arrays, queues, containers, stacks, linear tables, pointers, linked lists, trees, graphs, structures, classes, heaps, hash tables, etc.

The predefined in this disclosure can be understood as defined, defined in advance, stored, pre-stored, pre-negotiated, pre-configured, solidified, or pre-fired.

Ordinary technical personnel in this field can realize that the units and algorithm steps described in combination with the embodiments disclosed in this article can be implemented using electronic hardware, or a combination of computer software and electronic hardware. Whether these functions are executed in hardware or software depends on the specific application and design constraints of the technical solution. Professional technicians can use different methods to achieve the described functionality for each specific application, but such implementation should not be considered beyond the scope of this disclosure.

Technicians in the relevant field can clearly understand that, for e convenience and simplicity of description, the specific working processes of the systems, devices, and units described at refer to the corresponding processes in the aforementioned method embodiments, which will not be repeated here:

The above is only a specific implementation of the present disclosure, but the scope of protection of the present disclosure is not limited to this. Any skilled person familiar with the technical field can easily think of changes or replacements within the technical scope disclosed in the present disclosure, which should be included in the scope of protection of the present disclosure. Therefore, the scope of protection of this disclosure should be based on the scope of protection of the claims.

1. A method for reporting channel status information, performed by a terminal, comprising:
reporting channel status information (CSI) to a network device, wherein the CSI comprises quantized information obtained after downlink channel information is processed by a first model corresponding to each layer or a specific rank.

2. The method of claim 1, wherein reporting the CSI to the network device comprises:
reporting the CSI to the network device according to a determined maximum load.

3. The method of claim 2, further comprising:
determining the maximum load according to the first model adopted and/or first configuration information received from the network device, wherein the first configuration information indicates a rank constraint condition.

4. The method of claim 3, further comprising:
receiving second configuration information sent by the network device, wherein the second configuration information indicates a plurality of candidate first models; and
determining one of the plurality of candidate first models as the first model adopted.

5. The method of claim 1, wherein the CSI further comprises at least one of:
a rank indication (RI);
a channel quality indicator (CQI);
indication information of the first model;
indication information of a second model matched with the first model; or
indication information of a model pair of the first model and the second model matched;
wherein the second model is configured to process the quantized information to recover predicted downlink channel information similar to the downlink channel information.

6. The method of claim 1, further comprising:
sending model indication information to the network device, wherein the model indication information indicates at least one of:
indication information of the first model;
indication information of a second model matched with the first model; or
indication information of a model pair of the first model and the second model matched;
wherein the second model is configured to process the quantized information to recover predicted downlink channel information similar to the downlink channel information.

7. The method of claim 1, wherein reporting the CSI to the network device comprises:
reporting a first part of information and a second part of information to the network device at different moments, wherein the CSI comprises the first part of information and the second part of information;
wherein, reporting the first part of information and the second part of information to the network device comprises:
reporting the first part of information to the network device using a PUSCH or a PUCCH; and
reporting the second part of information to the network device using a PUSCH or a PUCCH.

8. (canceled)

9. The method of claim 7, wherein reporting the first part of information and the second part of information to the network device comprises:
reporting the first part of information and the second part of information to the network device periodically; or
reporting the first part of information and the second part of information to the network device non-periodically; or
reporting the first part of information and the second part of information to the network device semi-continuously;
wherein the first part of information is associated with the second part of information following and adjacent to the first part of information.

10. The method of claim 7, wherein the first part of information comprises at least one of:
RI;
CQI;
indication information of the first model; or
indication information of a second model matched with the first model;
wherein the second part of information comprises at least one of:
the quantized information obtained after the downlink channel information is processed by the first model corresponding to each model;
lengths of the quantized information of all layers obtained after the downlink channel information is processed by the first models corresponding to the all layers;
quantities of code words of all layers obtained after the downlink channel information is processed by the first models corresponding to the all layer;
the quantized information obtained after the downlink channel information is processed by the first model corresponding to the specific rank; or
indication information of the first model.

11. (canceled)

12. The method of claim 10, wherein data input to the first model comprises a precoding matrix in a space-frequency domain, or a precoding matrix in an angle-time delay domain, and wherein in a case where the data input to the first model is the precoding matrix in the angle-time delay domain, the second part of information further comprises indication information of spatial and frequency domain basis vectors selected by the terminal.

13-14. (canceled)

15. A method for reporting channel status information, performed by a network device, comprising:
receiving CSI reported by a terminal, wherein the CSI comprises quantized information obtained after downlink channel information is processed by a first model corresponding to each layer or a specific rank.

16. The method of claim 15, wherein receiving the CSI reported by the terminal comprises:
receiving the CSI reported by the terminal according to a determined maximum load.

17. The method of claim 16, further comprising:
sending first configuration information to the terminal, wherein the first configuration information is used for the terminal to determine the maximum load, and the first configuration information indicates a rank constraint condition.

18. The method of claim 15, wherein the CSI further comprises at least one of:
rank indication (RI);
a channel quality indicator (CQI);
indication information of the first model;
indication information of a second model matched with the first model; or
indication information of a model pair of the first model and the second model matched;
wherein the second model is configured to process the quantized information to recover predicted downlink channel information similar to the downlink channel information.

19. The method of claim 15, further comprising:
receiving model indication information sent by the terminal, wherein the model indication information indicates at least one of:
indication information of the first model;
indication information of a second model matched with the first model; or
indication information of a model pair of the first model and the second model matched;
wherein the second model is configured to process the quantized information to recover predicted downlink channel information similar to the downlink channel information.

20. The method of any of claim 15, wherein receiving the CSI reported by the terminal comprises:
receiving a first part of information and a second part of information reported by the terminal at different moments, wherein the CSI comprises the first part of information and the second part of information;
wherein receiving the first part of information and the second part of information reported by the terminal comprises:
receiving the first part of information reported by the terminal using a PUSCH or a PUCCH; and
receiving the second part of information reported by the terminal using a PUSCH or a PUCCH;
or,
wherein receiving the first part of information and the second part of information reported by the terminal comprises:
receiving the first part of information and the second part of information reported by the terminal periodically; or
receiving the first part of information and the second part of information reported by the terminal non-periodically; or
receiving the first part of information and the second part of information reported by the terminal semi-continuously;
wherein the first part of information is associated with the second part of information following and adjacent to the first part of information.

21-22. (canceled)

23. The method of claim 20, wherein the first part of information comprises at least one of:
RI;
CQI;
indication information of the first model; or
indication information of a second model matched with the first model;
wherein the second part of information comprises at least one of:
the quantized information obtained after the downlink channel information is processed by the first model corresponding to each model;
the quantized information obtained after the downlink channel information is processed by the first model corresponding to the specific rank; or
indication information of the first model.

24. (canceled)

25. The method of claim 23, wherein data input to the first model comprises a precoding matrix in a space-frequency domain, or a precoding matrix in an angle-time delay domain, and wherein in a case where the data input to the first model is the precoding matrix in the angle-time delay domain, the second part of information further comprises indication information of spatial and frequency domain basis vectors selected by the terminal.

26-29. (canceled)

30. A terminal, comprising a processor and a memory, wherein the memory stores a computer program, and the processor is configured to execute the computer program stored in the memory, so as to:
report channel status information (CSI) to a network device, wherein the CSI comprises quantized information obtained after downlink channel information is processed by a first model corresponding to each layer or a specific rank.

31-32. (canceled)

33. A network device, comprising a processor and a memory, wherein the memory stores a computer program, and the processor is configured to execute the computer program stored in the memory, so as to cause the network device to implement the method of claim 15.
